(19) United States
(12) Patent Application Publication
(10) Pub. No.: US 2026/0078616 A1
(43) Pub. Date: Mar. 19, 2026

(54) VEHICLE LATCH

(71) Applicant: Inteva Products, LLC, Troy, MI (US)

(72) Inventors: Hector Sanchez Rojas, Ciudad Juarez (MX); Pedro Alfredo Alvarado Heredia, Ciudad Juarez (MX); Ari Yusel Mino Ramirez, Ciudad Juarez (MX); Donald Michael Perkins, Rochester Hills, MI (US); Marc Wilson, Waterford, MI (US)

(21) Appl. No.: 19/282,548

(22) Filed: Jul. 28, 2025

Related U.S. Application Data
(60) Provisional application No. 63/679,397, filed on Aug. 5, 2024.
(60) Provisional application No. 63/703,389, filed on Oct. 4, 2024.
(60) Provisional application No. 63/722,063, filed on Nov. 18, 2024.
(60) Provisional application No. 63/851,306, filed on Jul. 25, 2025.

(51) Int. Cl. E05B 81/16; E05B 81/06; E05B 81/30; E05B 81/34; E05B 81/42; E05B 81/46

(52) U.S. Cl. CPC E05B 81/16; E05B 81/06; E05B 81/30; E05B 81/34; E05B 81/42; E05B 81/46

(57) ABSTRACT

A vehicle latch (1), including: an actuator (4), the actuator including: an actuator gear (10) and a single motor (50), the single motor (50) rotates the actuator gear (10) about an axis in a first direction from a home position to a release position and a second direction opposite to the first direction from either the release position or only from the home position to a second position, wherein rotation of the actuator gear (10) to the release position opens the vehicle latch (1) and rotation of the actuator gear (10) from only the home position to the second position unlocks the vehicle latch such that operation of an outside release lever will open the vehicle latch (1).

### CROSS REFERENCE TO RELATED APPLICATIONS

The present application claims priority to the following provisional applications U.S. Provisional Patent Application Ser. No. 63/679,397 filed on Aug. 5, 2024; U.S. Provisional Patent Application Ser. No. 63/703,389 filed on Oct. 4, 2024; U.S. Provisional Patent Application Ser. No. 63/722,063 filed on Nov. 18, 2024; and U.S. Provisional Patent Application Ser. No. 63/851,306 filed on Jul. 25, 2025, the entire contents each of which are incorporated herein by reference thereto.

### BACKGROUND

Exemplary embodiments of the present disclosure pertain to the art of vehicle latches. In some applications, the vehicle latch must be configured to operate when the vehicle has be involved in a collision or where there has been damage to the vehicle the vehicle latch is secured to.

In a vehicle door latch or vehicle door latch assembly it is desirable to provide the vehicle latch or vehicle latch assembly that offers many electrical and mechanical functions while maintaining a relatively small package with the ability of fitting on a variety of designs.

It is also desirable to provide a vehicle latch or vehicle latch assembly that provides numerous electrical and mechanical functions in certain vehicle conditions.

### BRIEF DESCRIPTION

Disclosed is a vehicle latch or vehicle latch assembly that uses a single motor to perform both electrical release and crash unlock function.

Disclosed is a vehicle latch, including: an actuator, the actuator including: an actuator gear and a single motor, the single motor rotates the actuator gear about an axis in a first direction from a home position to a release position and a second direction opposite to the first direction from either the release position or only from the home position to a second position, wherein rotation of the actuator gear to the release position opens the vehicle latch and rotation of the actuator gear from only the home position to the second position unlocks the vehicle latch such that operation of an outside release lever will open the vehicle latch.

In addition to one or more of the features described above, or as an alternative to any of the foregoing embodiments, the actuator gear includes a cam face integrally formed with the actuator for contacting a release lever when the actuator gear is rotated into the release position.

In addition to one or more of the features described above, or as an alternative to any of the foregoing embodiments, the single motor drives a worm that meshingly engages teeth of the actuator gear.

In addition to one or more of the features described above, or as an alternative to any of the foregoing embodiments, the actuator further comprises: a lock clutch lever; a lock lever; a release lever; a control lever; each rotatably mounted to a housing of the actuator, the control lever and the actuator gear rotatably mounted the axis, and an actuator return spring located between the control lever and the actuator gear and providing a biasing force between the control lever and the actuator gear when the actuator gear is rotated with respect to the control lever.

In addition to one or more of the features described above, or as an alternative to any of the foregoing embodiments, the control lever has a feature that limits rotation of the control lever with respect to the actuator housing as the control lever rotates with respect to the actuator housing and the feature contacts a feature of the actuator housing.

In addition to one or more of the features described above, or as an alternative to any of the foregoing embodiments, the control lever has a feature that contacts a feature of the actuator gear when the actuator gear rotates with respect to the control lever.

In addition to one or more of the features described above, or as an alternative to any of the foregoing embodiments, one end of the actuator return spring is retained by a feature of the actuator housing and another end is retained by a feature of the actuator gear.

In addition to one or more of the features described above, or as an alternative to any of the foregoing embodiments, rotation of the actuator gear in first direction does not apply a force to the actuator return spring and rotation of the actuator gear in the second direction to the second position from the home position applies a force to the actuator return spring that causes the actuator spring to spring bias the actuator gear into the home position from the second position.

In addition to one or more of the features described above, or as an alternative to any of the foregoing embodiments, the lock clutch lever has a leg that is positioned between feature of the actuator gear and feature of the control lever when the actuator gear is in the home position and the control lever is in the second position.

In addition to one or more of the features described above, or as an alternative to any of the foregoing embodiments, the feature contacts the leg and rotates the lock clutch lever when the actuator gear is rotated from the home position in the second direction and the control lever is in the second position.

In addition to one or more of the features described above, or as an alternative to any of the foregoing embodiments, rotation of the lock clutch lever by feature when the actuator gear is rotated from the home position in the second direction and the control lever is in the second position causes rotation of the lock lever operably coupled to the lock clutch lever which causes rotation of a bypass lever rotatably mounted to the release lever, a position of the bypass lever determines whether rotational movement of the outside release lever will cause the vehicle latch to be opened.

In addition to one or more of the features described above, or as an alternative to any of the foregoing embodiments, the actuator gear includes a cam face integrally formed with the actuator for contacting a release lever when the actuator gear is rotated into the release position and the single motor drives a worm that meshingly engages teeth of the actuator gear.

In addition to one or more of the features described above, or as an alternative to any of the foregoing embodiments, a control lever is rotatably secured to an actuator housing and the control lever has a feature that limits rotation of the control lever with respect to the actuator housing as the control lever rotates with respect to the actuator housing and the feature contacts a feature of the actuator housing.

In addition to one or more of the features described above, or as an alternative to any of the foregoing embodiments, the control lever has a feature that contacts a feature of the actuator gear when the actuator gear rotates with respect to the control lever, the feature being on one side of the control lever and the feature is located on an opposite side of the control lever.

In addition to one or more of the features described above, or as an alternative to any of the foregoing embodiments, a lock control system is placed into an unlock condition when the actuator gear is rotated only the home position to the second position.

In addition to one or more of the features described above, or as an alternative to any of the foregoing embodiments, the actuator gear is spring biased into the home position from the second position.

In addition to one or more of the features described above, or as an alternative to any of the foregoing embodiments, after the actuator gear is rotated into the release position, the actuator gear is then rotated into the second position by the single motor wherein movement of the actuator gear directly from the release position to the second position does not unlock the vehicle latch such that operation of the outside release lever will not open the vehicle latch.

In addition to one or more of the features described above, or as an alternative to any of the foregoing embodiments, the actuator gear includes a cam face integrally formed with the actuator for contacting and rotating a release lever when the actuator gear is rotated into the release position, wherein the release lever is configured to be rotated by an outside release lever when a locking mechanism of the vehicle latch is in an unlocked state.

In addition to one or more of the features described above, or as an alternative to any of the foregoing embodiments, the locking mechanism further comprises a bypass lever rotatably mounted to the release lever, the bypass lever operably coupling an outside release lever to the release lever.

Also disclosed is a method for power opening and power unlocking a vehicle latch with a single motor, including: rotating an actuator gear with the single motor about an axis in a first direction from a home position to a release position and a second direction opposite to the first direction from either the release position or only from the home position to a second position, wherein rotation of the actuator gear to the release position opens the vehicle latch and rotation of the actuator gear from only the home position to the second position unlocks the vehicle latch such that operation of an outside release lever will open the vehicle latch.

### BRIEF DESCRIPTION OF THE DRAWINGS

FIG. 1 is a perspective view of a vehicle latch or vehicle latch assembly in accordance with the present disclosure;

FIG. 2 is a perspective view of portion of an interior of the vehicle latch or vehicle latch assembly in accordance with the present disclosure;

FIG. 3 is an exploded view of portions of an actuator of the vehicle latch or vehicle latch assembly in accordance with the present disclosure in accordance with the present disclosure;

FIG. 4 illustrates components of the actuator of the vehicle latch or vehicle latch assembly in a home position in accordance with the present disclosure;

FIG. 5 illustrates components of the actuator of the vehicle latch or vehicle latch assembly in a release position in accordance with the present disclosure;

FIG. 6 illustrates components of the actuator of the vehicle latch or vehicle latch assembly in an unlock position in accordance with the present disclosure;

FIGS. 7-7F illustrate components of the actuator of the vehicle latch or vehicle latch assembly in accordance with the present disclosure;

FIG. 8 is a perspective view of an actuator gear of the vehicle latch or vehicle latch assembly in accordance with the present disclosure;

FIG. 8A is cross-sectional view of the actuator gear illustrated in FIG. 8;

FIG. 9 is a perspective view of an actuator gear of the vehicle latch or vehicle latch assembly in accordance with the present disclosure;

FIG. 9A is cross-sectional view of the actuator gear illustrated in FIG. 9;

FIGS. 9B and 9C are additional cross-sectional views of the actuator gear illustrated in FIG. 9;

FIGS. 10A-10C illustrate movement of the control lever and a gear control lever feature in accordance with the present disclosure;

FIGS. 11A and 11B illustrate the lock control system of the vehicle latch or vehicle latch assembly in accordance with the present disclosure;

FIG. 12 illustrates the lock control system of the vehicle latch or vehicle latch assembly in accordance with the present disclosure;

FIGS. 13A-16I illustrate movement of the lock control system of the vehicle latch or vehicle latch assembly in accordance with the present disclosure;

FIGS. 17A-18F illustrate the lock control system and bypass lever functionality of the vehicle latch or vehicle latch assembly in accordance with the present disclosure;

FIGS. 19A-21B illustrate components of the vehicle latch or vehicle latch assembly in accordance with the present disclosure; and

FIGS. 22-33C illustrate components of an alternative configuration of an actuator for the vehicle latch or vehicle latch assembly in accordance with the present disclosure.

### DETAILED DESCRIPTION

A detailed description of one or more embodiments of the disclosed apparatus and method are presented herein by way of exemplification and not limitation with reference to the attached Figures.

In accordance with the present disclosure, a vehicle latch or vehicle latch assembly is provided that uses a single motor to perform both electrical release and crash unlock function.

In one embodiment the location of the pawl on the vehicle latch or vehicle latch assembly ensures proper performance during an unfortunate crash event.

In accordance with the present disclosure, a power side door latch, vehicle latch or vehicle latch assembly is provided with anyone of the following electrical and mechanical functions:
Power release: A mechanism including a motor that provides electrical release of the power side door latch, vehicle latch or vehicle latch assembly, and the mechanism also enables back driving of the mechanism.
Crash lock/unlock: Function driven by the same motor used to perform power release. The crash lock/unlock is function also allows the power side door latch, vehicle latch or vehicle latch assembly to communicate with a vehicle controller in a crash event to unlock the power side door latch, vehicle latch or vehicle latch assembly and enable an outside release lever to mechanically open the power side door latch, vehicle latch or vehicle latch assembly. This function is also activated after the vehicle recovers from the collision, to move the mechanism of the power release in a back drive direction after performing a power release actuation to return the mechanism to its home position, which corresponds to a locked state of the power side door latch, vehicle latch or vehicle latch assembly. This mechanism can also be configured to work together with operational logic of the vehicle the power side door latch, vehicle latch or vehicle latch assembly is installed in.
Power child lock: An electrical mechanism located within the power side door latch, vehicle latch or vehicle latch assembly. The electrical mechanism when activated blocks an inside release lever on a rear door power side door latch, vehicle latch or vehicle latch assembly to prevent a child from opening the vehicle door. An additional motor is provided to perform this function.
Inside release: This mechanism allows a user to release the power side door latch, vehicle latch or vehicle latch assembly from an inside of the vehicle. This mechanism connects a release cable to a lever within the power side door latch, vehicle latch or vehicle latch assembly to accomplish the inside release function.
Service release: allows the release of the power side door latch, vehicle latch or vehicle latch assembly from the outside in a crash event. This function is accomplished by a cable connected to an outside release lever of the power side door latch, vehicle latch or vehicle latch assembly.
Key lock/unlock: allows the manual locking or unlocking in a drained battery situation. This function and associated mechanism connects a key cylinder lever within the power side door latch, vehicle latch or vehicle latch assembly to an external rod to allow the lock/unlock functions.
Emergency Lock: This feature allows a user to manually lock the power side door latch, vehicle latch or vehicle latch assembly if the power is lost to the power side door latch, vehicle latch or vehicle latch assembly.

Another feature for this the power side door latch, vehicle latch or vehicle latch assembly is the fact that a pawl is located above a striker releasably retained by the power side door latch, vehicle latch or vehicle latch assembly when the power side door latch, vehicle latch or vehicle latch assembly is secured to a vehicle, ensuring that the pawl will remain in primary closed position during a collision even if the pawl spring gets damaged.

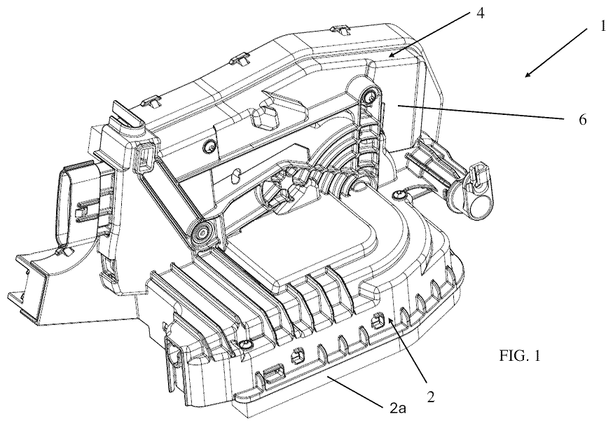

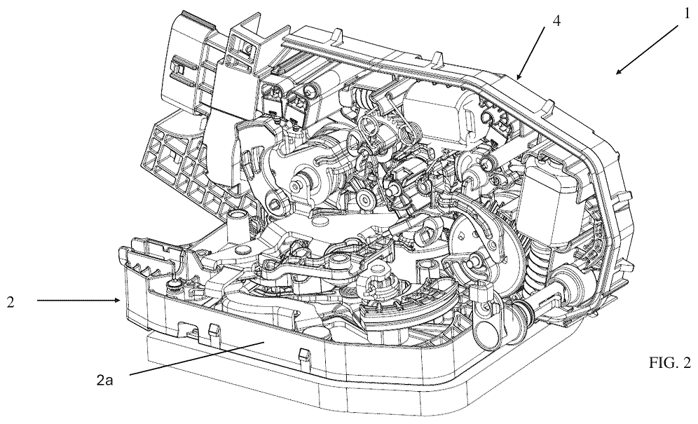

Referring now to at least FIGS. 1 and 2, a power side door latch, vehicle latch or vehicle latch assembly 1 is illustrated. The power side door latch, vehicle latch or vehicle latch assembly 1 includes a latch 2 operably coupled to an actuator 4. In one non-limiting embodiment, the power side door latch, vehicle latch or vehicle latch assembly 1 is configured for use with a side door of a vehicle. In FIG. 2, the power side door latch, vehicle latch or vehicle latch assembly 1 is shown with a cover 6 removed.

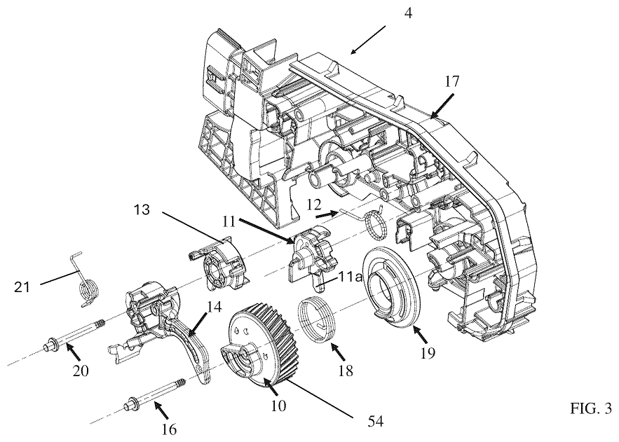

Referring now to FIG. 3 an exploded view of portions of the actuator 4 of the power side door latch, vehicle latch or vehicle latch assembly 1 is illustrated.

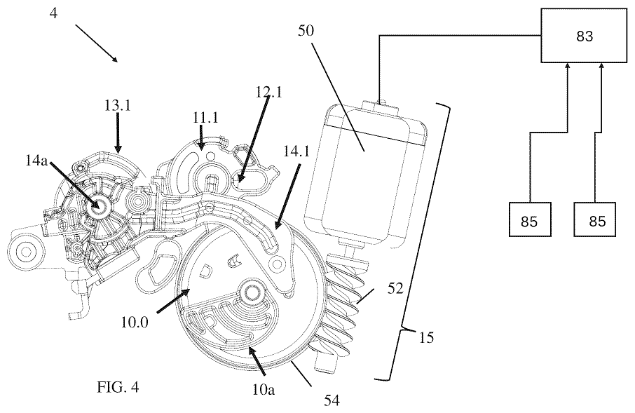

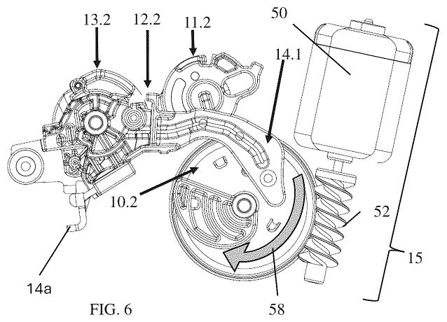

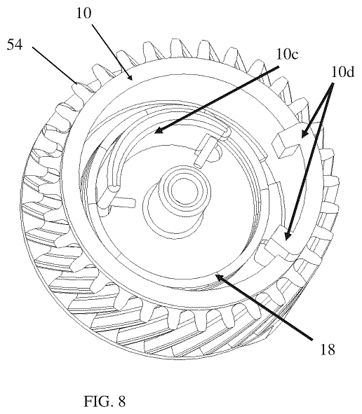

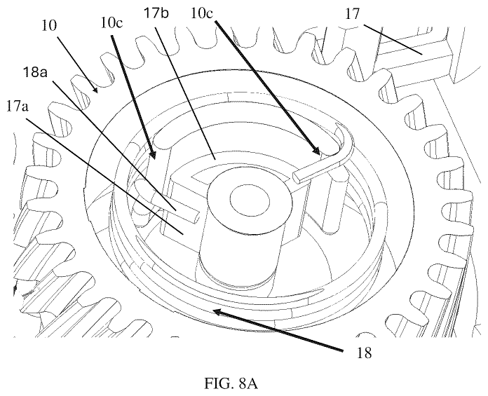

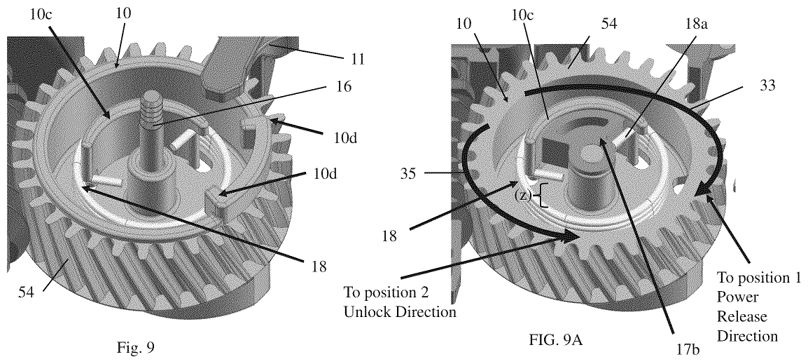

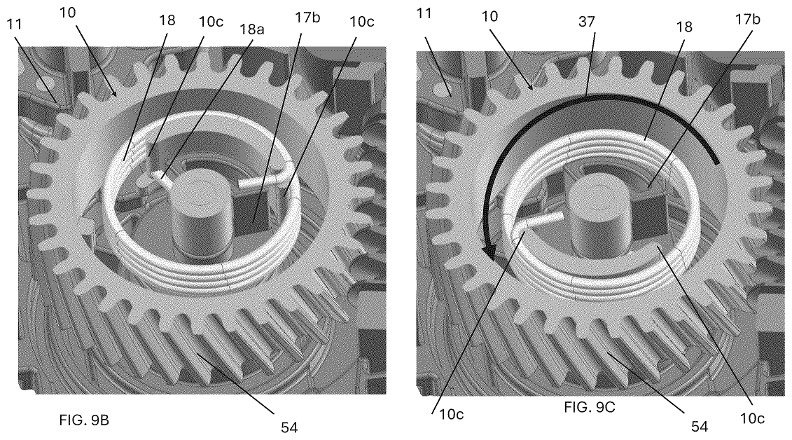

As shown in at least FIGS. 3-6, portions of the actuator 4 are illustrated. In at least FIGS. 3-6, is an actuator gear 10, a lock clutch lever 11, a lock clutch spring 12, a lock lever 13, a release lever or cam lever 14, an actuator pivot 16, an actuator housing 17, an actuator return spring 18, a control lever or locking disc 19 and a cam follower lever pivot 20. The actuator housing 17 is configured to position and restrain all components of the actuator 4. The actuator 4 is retained by the actuator housing 17 and the actuator pivot 16 secures the actuator gear 10 to the actuator housing 17 which pivots about the actuator pivot 16. Also illustrated is an actuator return spring 18 acts upon the actuator gear 10 to return the actuator gear 10 to its neutral or home position (position 0) (see at least FIG. 4) from an unlock position (position 2) (see at least FIG. 6) once a motor 50 for driving the actuator gear 10 is de-energized. The actuator return spring 18 is also retained by the housing 17 to act as a static element. See also FIGS. 8, 8A, 9, 9A, 9B, 9C, 10A, 10B and 10C.

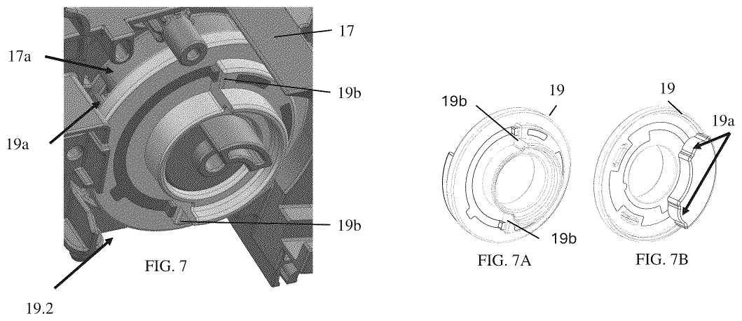

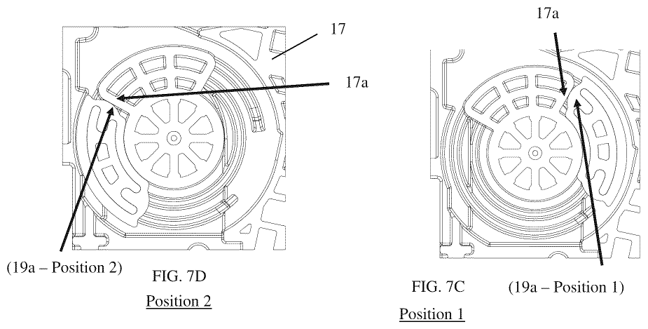

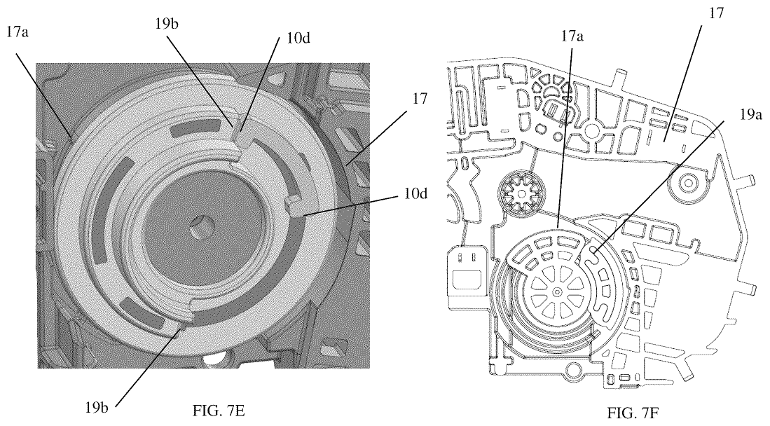

A control lever 19 is rotatably received on the actuator housing 17 and is driven by the actuator gear 10. The end of travel of the control lever 19 is controlled by the actuator housing 17 (see at least FIGS. 7C and 7D).

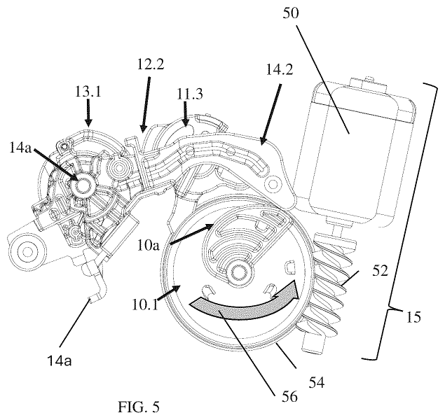

As used herein, the following positions of the actuator 4 and associated components are illustrated and as described as follows: position 0 (home or neutral position, see at least FIG. 4); position 1 (release position, see at least FIG. 5); and position 2 (actuator return stop or return stop), see at least FIG. 6). Note: the actuator does not always end up in an unlock state when the actuator reaches position 2. In accordance with various embodiments of the present disclosure the actuator 4 always returns to the home or neutral position whether it is moved from the home or neutral position to the release position first or whether it is moved from the home or neutral position to the unlock position. During power release, the actuator 4 is moved from the home or neutral position (position 0) to the release position (position 1). After the actuator 4 has reached the release position (position 1) the actuator 4 is powered to move from the release position (position 1) to the position 2 and thereafter, the actuator 4 is moved back into the home or neutral position (position 0). The movement of the actuator 4 from the position 2 to the home or neutral position (position 0) is provided by a spring biasing force. As such, the actuator 4 is always returned to the home or neutral position (position 0) by a spring biasing force regardless of whether the operation of the actuator is a power release or a power unlock. The final state of the actuator 4 after power release depends on the initial state of the actuator 4 prior to power release. For example, if the actuator 4 is in the unlocked state prior to power release from the home position when the actuator is returned into the home position the actuator 4 will be in locked state. If on the other hand, the actuator 4 is in locked state prior to power release from the home position when the actuator is returned into the home position the actuator 4 will be in locked state.

If the actuator 4 is moved from the home or neutral position (position 0) to position 2 (actuator return stop or return stop) when the actuator 4 is in the locked state when the actuator 4 is moved back to the home or neutral position (position 0) via the actuator return spring, the power side door latch, vehicle latch or vehicle latch assembly 1 is unlocked and can be opened via actuation of an outside handle operably coupled to an outside release lever of the power side door latch, vehicle latch or vehicle latch assembly 1.

As mentioned above, if the actuator 4 is subsequently moved from the home or neutral position (position 0), when the actuator is in an unlocked state, to release position (position 1) during a power release operation, the actuator is then back driven electrically from the release position (position 1) to the actuator return stop or return stop position (position 2) and then the actuator 4 is moved back to the home or neutral position (position 0) from the actuator return stop or return stop position (position 2) and the power side door latch, vehicle latch or vehicle latch assembly 1 is now in a locked state.

Note if the actuator 4 is moved directly (e.g., not a power release operation) from the home or neutral position (position 0) to position 2 (actuator return stop or return stop) when the actuator 4 is in the unlocked state when the actuator 4 is moved back to the home or neutral position (position 0) via the actuator return spring, the power side door latch, vehicle latch or vehicle latch assembly 1 remains unlocked.

As such, the actuator is always returned from the actuator return stop position (position 2) to the home position because of the actuator return spring 18. In the home position, the power side door latch, vehicle latch or vehicle latch assembly 1 can be unlocked by cycling the actuator to the actuator return stop position (position 2). When the actuator 4 of the power side door latch, vehicle latch or vehicle latch assembly 1 is moved to the position 1 (release position) from the home position the power side door latch, vehicle latch or vehicle latch assembly 1 is released via a power release operation. Then the actuator 4 is moved to position 2 (actuator return stop position) and then back to the home position, and will be in a locked state. The actuator is always in a locked state after release operation regardless of the state of the actuator prior to power release. When the actuator 4 is moved to position 2 during a power unlock operation the actuator is moved from the home position to the actuator return stop or return stop position and then biased back to the home position.

In FIG. 4, the actuator 4 is in position 0 or the home position. Also shown is an actuator drive system or actuator motor assembly 15 which includes a motor 50 operably coupled to a worm 52, which is configured to engage teeth 54 of the actuator gear 10. The actuator 10 also has a cam face 10a that extends from one surface of the actuator 10. In one non-limiting embodiment, the cam face 10a is integrally formed with the actuator 10 as a single unitary component. In this position (illustrated in FIG. 4), the actuator gear 10 is in position 0 (the neutral position) and the actuator gear cam face 10a is in position 0 while the lock clutch lever 11 is in position 1 and is labeled as 11.1. Similarly, the lock clutch spring 12 is in position 1 and is labeled as 12.1 and the lock lever 13 is in position 1 and is labeled as 13.1, and the release lever 14 is in position 1 and is labeled as 14.1.

As illustrated in at least FIG. 4, the release lever 14 (identified as 14.1 is in position 1) is rotatable about a pivot 14a and follows the actuator gear cam face 10a. The lock clutch lever 11 (identified as 11.1 is in position 1) interfaces with the actuator gear 10 (identified as 10.0 is in the neutral position) on an opposite side as shown (e.g., the opposite side of the actuator gear cam face 10a), and the lock clutch spring 12 (identified as 12.1 is in position 1).

The lock clutch spring 12 (identified as 12.1 is in position 1) is held in a static position by the lock clutch lever 11 (identified as 11.1 is in position 1) and interfaces with the lock lever 13 (13.1=position 1). As illustrated, the lock lever 13 is rotatable about pivot 14a.

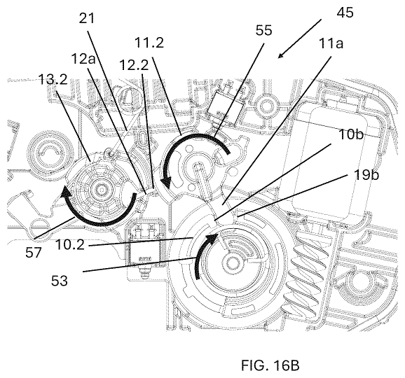

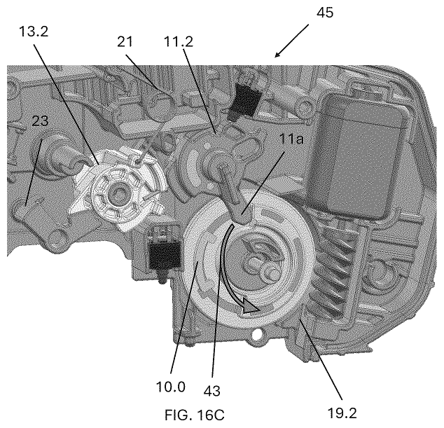

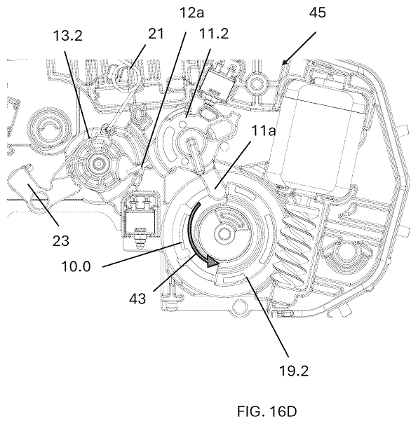

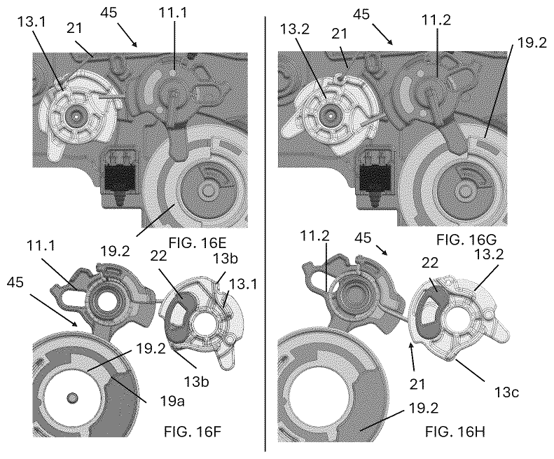

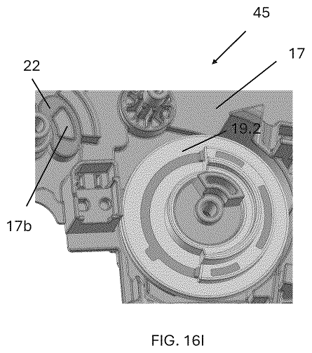

Referring now to at least FIG. 5, the actuator 4 is now in position 1 or the release position beginning from the neutral or home position illustrated in at least FIG. 4. Here, the actuator gear 10 has been rotated into position 1 or the release position (identified as 10.1 is position 1 of the actuator gear 10). Also, the actuator gear cam face 10a, which is integrally formed with the actuator gear has also been rotated into position 1 after the actuator gear 10 has been rotated counter clockwise (with respect to the view illustrated in at least FIG. 5) in the direction of arrow 56. This movement of the actuator gear 10 causes the cam face 10a to drive the release lever 14 to position 2 labeled as 14.2. In addition, the lock clutch lever 11 is in a bypass position (position 3) labeled as 11.3. The movement of the lock clutch lever 11 into the bypass position (position 3 labeled as 11.3) is due to features 10d located on an opposite face of the actuator gear 10 that contact an arm portion 11a of the lock clutch 11. See at least FIG. 11A. The lock clutch spring 12 is in position 2 (labeled as 12.2, which is not seen in FIG. 5). The lock clutch spring 12 is compressed by the lock clutch lever 11 when the lock clutch spring 12 is in position 2 and the lock clutch lever is in position 3 (labeled as 11.3). See at least FIG. 16A. This is due to the fact that the lock clutch spring 12 interfaces with the lock lever when it is in position 1 labeled as 13.1. As illustrated, the lock lever 13 remains in position 1 labeled as 13.1 when the actuator gear 10 is in the position 1 (the release position labeled as 10.1) and the release lever 14 is in position 2 labeled as 14.2. As such, the lock lever 13 remains stationary during this phase of actuation.

The lock clutch lever 11 is driven to a bypass position (position 3 labeled as 11.3) by features 10d on an opposite face of the actuator gear 10. See at least FIGS. 8, 9 and 10A-16D. The lock clutch spring 12 is compressed by the lock clutch lever 11 when it is in position 3 labeled as 11.3, and interfaces with the lock lever 13 which is in position 1 labeled as 13.1. The lock lever 13 remains stationary in position 13.1 during this phase of actuation.

Referring now to at least FIG. 6, the actuator 4 is now in position 2 or the actuator return stop position. The actuator return stop position may be achieved from at least two movements 1) from the neutral position 0 to the release position 1 and then to position 2 or the actuator return stop position 2 after passing through the neutral position 0 or 2) directly from the neutral position 0 to position 2 or the actuator return stop position. In other words, even though the actuator 4 always starts from the home position and reaches actuator return stop position or position 2 and then returns to the home position the movement to the actuator return stop position or position 2 does not always result in an unlock condition. This unlock condition only occurs if the movement to the actuator return stop position or position 2 occurs directly from the neutral position 0 and does not include movement to the release position 1. This movement is illustrated in FIG. 6. In this position illustrated in FIG. 6, the actuator gear 10 is in position 2 (the actuator return stop or return stop position) labeled as 10.2 and the lock clutch lever 11 is in position 2 (the unlock position) labeled as 11.2. In addition, the lock clutch spring 12 (not seen in this view) is in position 2 (the unlock position) labeled as 12.2. The lock lever 13 is in position 2 (the unlock position) labeled as 13.2 and the release lever 14 is in position 1 (the home position) labeled as 14.1.

The position of the actuator gear 10 illustrated in FIG. 6 began directly from the neutral position as described and illustrated in FIG. 4 and did not include the release position (position 1), if on the other had it had returned to this position from the release position (position 1) the actuator 4 will remain in a locked stated. In FIG. 6, the actuator gear 10 has been driven clockwise (with respect to the view in at least FIG. 6) in the direction of arrow 58 to position 2, the actuator return stop or return stop position, labeled as 10.2 from the home position 0 (illustrated in FIG. 4). During this movement, the lock clutch lever 11 is driven to the unlock position 2 labeled as 11.2 by features 10d on an opposite face of the actuator gear 10.

The lock clutch spring 12 in position 2 labeled as 12.2 is held in a static position by the lock clutch lever 11, and interfaces with the lock lever 13 in position 2 labeled as 13.2.

The lock lever 13 (in position 13.2) rotates to another position via force from the lock clutch spring 12 when it is in position 12.2.

Referring now to at least FIGS. 7-7F, movement of the control lever 19 with respect to the actuator housing 17 is illustrated. The control lever 19 has a position control feature 19a that extends from a surface of the control lever 19. In one non-limiting embodiment, the position control feature 19a is integrally formed with the control lever 19 such that they are formed as a single component. The position control feature 19a is configured to engage opposite ends of an actuator stop feature 17a integrally formed with the actuator housing 17. In one non-limiting embodiment, the actuator stop feature 17a is integrally formed with the actuator housing 17 such that they are formed as a single component. Contact of the position control feature 19a with either one of the ends of the actuator stop feature 17a will define limits of travel of the control lever 19. In at least FIGS. 7 and 7D, the control lever 19 is in position 2 corresponding to the unlock position which is labeled as 19.2 where one end of the position control feature 19a has contacted one end of the actuator stop feature 17a. In FIG. 7C, the control lever 19 is in position 1 corresponding to the unlock position which is labeled as 19.2 and an opposite end of the position control feature 19a has contacted an opposite end of the actuator stop feature 17a. As such, the end stop feature 17a integrated into the actuator housing 17 interfaces with the travel end stop features of the position control feature 19a integrated into the control lever 19 thus determining position 1 and position 2 of the control lever 19. In FIGS. 7D and 7C only the control features 19a of the control lever 19 are illustrated.

FIGS. 7E and 7F are additional views of the control lever 19 in position 1. In FIG. 7E only the features 10d of the actuator gear 10 are illustrated and in FIG. 7F only the control features 19a of the control lever 19 are illustrated. In FIG. 7F, the control lever 19 is in the power release position.

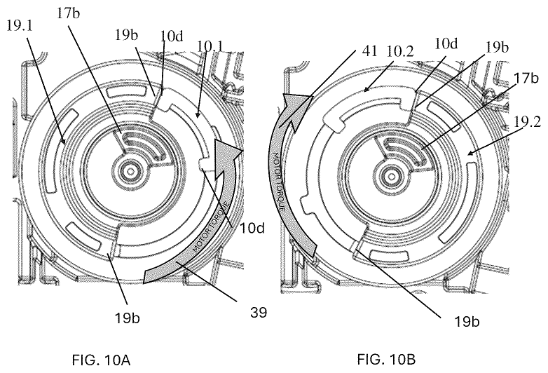

Referring now to at least FIGS. 8-9C, features of the actuator return spring 18 and the actuator gear 10 are illustrated. As illustrated, a feature 10c on a cavity side of the actuator gear 10 retains the actuator return spring 18 relative to the geometry of the gear 10. Note: the cavity side of the actuator gear 10 faces the control lever 19 when the control lever 19 and the actuator gear 10 are rotatably mounted to the actuator housing 17. FIG. 8A is a cross sectional view of an opposite side of the gear 10 illustrated in FIG. 8 where a feature or housing spring retainer 17b of the housing 17 is illustrated. FIG. 9A is a cross-sectional view of the actuator gear 10 where a portion of the housing spring retainer 17b is also illustrated in cross section.

Feature or housing spring retainer 17b on the actuator housing 17 positions the actuator return spring 18 relative to the actuator housing geometry. The actuator housing 17 includes the housing spring retainer 17b. The actuator gear 10 also has a gear spring retainer 10c and a gear control lever drive feature 10d. The actuator housing 17 has a housing spring retainer 17b.

Feature 10d of the actuator 10 interfaces and drives the control lever 19 to positions 1 or 2 as the actuator gear 10 is rotated.

As illustrated in at least FIG. 9A, the actuator housing spring feature 17b height from the housing 17 is predetermined to allow a clearance (z) to the actuator return spring 18 as the actuator gear 10 rotates to position 1 (release direction) illustrated by arrow 33 thus no torque is transferred to the actuator gear 10. This is due to the fact that actuator return spring 18 does not engage feature 17b when it is rotated to position 1 in the release direction illustrated by arrow 33. The actuator gear 10 is returned electrically by the actuator motor assembly 15 from position 1 until it reaches position 2 in the direction of arrow 35.

Conversely, the feature 17b will engage leg 18a of the spring 18 as the actuator gear 10 rotates to position 2 (unlock direction) in the direction of arrow 35 thus supplying a torque upon the actuator gear 10 to return it to position 0 (home position) when the motor 50 is energized and the biasing force of spring 18 returns the actuator gear 10 to return it to position 0 (home position).

During rotation of the gear 10, feature 10d interfaces, and drives, the control lever 19 to positions 1 and 2. FIG. 9C illustrates the biasing force of spring 18 in the direction of arrow 37 which returns the gear 10 to the home position.

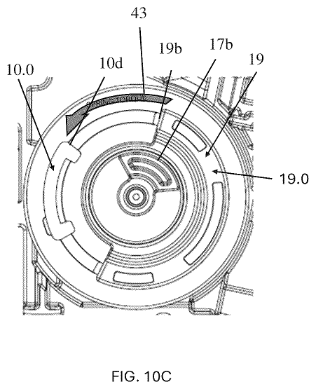

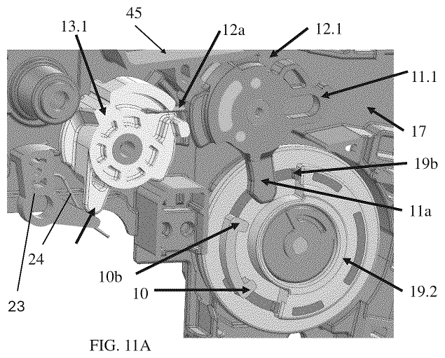

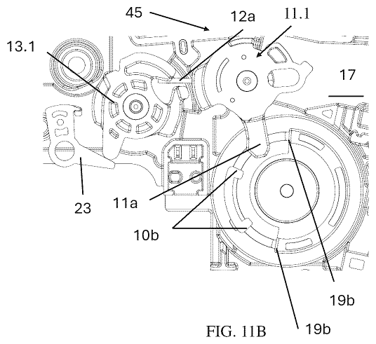

Referring now to at least FIGS. 10A-10C, the relationship between the control lever 19 and the drive features 10d of gear 10 are illustrated. In FIG. 10A, the actuator gear 10 is driven electrically to position 1 by the motor 50 (labeled as 10.1). This motor torque is illustrated by arrow 39. Also shown is the features 10d, the motor 50 of the motor assembly 15 will return gear 10 to position 2 (labeled as 10.2) after position 1 is reached. In FIG. 10A, the control lever 19 is in position 1 (labeled as 19.1) via control lever driven features 19b which are driven by features 10d as the gear 10 is rotated. In FIG. 10B, the actuator gear 10 is driven electrically to position 2 (labeled as 10.2) by the motor 50 of the motor assembly 15 and the control lever 19 is driven via the gear control lever drive features 10d and the control lever 19 is shown in position 2 (labeled as 19.2) as the gear control lever drive feature 10d contacts control lever driven features 19b. This motor torque is illustrated by arrow 41. The control lever driven features 19b are located on an opposite side with respect to the position control feature 19a. The addition and in one non-limiting exemplary embodiment the control lever driven features 19b are integrally formed with the control lever 19 such that they are formed as a single component.

In FIG. 10C, the actuator gear 10 is driven by the gear return spring 18 to position 0 (labeled as 10.0). The spring 18 will return actuator gear 10 to this position from position 2 when motor is de-energized. The spring biasing force is illustrated by arrow 43. As previously mentioned the spring biasing force in the direction of arrow 43 is generated by leg 18a of spring 18 contacting feature 17b of the housing 17 when the gear 10 is rotated to position 2. Here the control lever 19 is in position 0 (home position) as the spring 18 does not provide a biasing force to the control lever 19. Positions 1 and 2 of the control lever 19 are controlled via the control lever stop surfaces 19a which contact feature 17a of the housing 17 as described with respect to at least FIGS. 7-7D. In FIGS. 10A-10C only the features 10b of the actuator gear is illustrated.

Referring now to at least FIGS. 11A-11B, a lock control system 45 and method of operation of the vehicle latch or vehicle latch assembly 1 in accordance with the present disclosure is illustrated. The lock control system is configured to be actuated by rotation of the actuator gear 10 in order to place the vehicle latch or vehicle latch assembly 1 in a locked or unlocked state.

In FIGS. 11A and 11B the actuator gear 10 is in position (0) however only features or control drive features 10b of the actuator gear 10 are illustrated. Also, shown is the lock clutch lever 11 which is in position 1 identified as 11.1, the lock clutch lever 11 has leg 11a that is driven by rotational movement of the actuator gear 10 in order to place the vehicle latch or vehicle latch assembly 1 in a locked or unlocked state. The lock clutch spring 12 is illustrated in position 1 identified as 12.1. Also shown is a lock clutch spring extended leg 12a, which is configured to interact with the lock lever 13. The lock lever 13 is in position 1 and the control lever 19 is in position 2. Also shown are the control lever drive features 19b. Also illustrated is a lock lever spring 21 and a bypass lever 23. The lock lever spring 21 is secured to the housing 17 at one end and the lock lever at another end. The lock lever spring 21 in one non-limiting embodiment is an over center spring. The over center spring 21 will help us to maintain either the locked or unlocked position of the lock lever 13.

As such, the vehicle latch or vehicle latch assembly 4 includes housing 17 that positions and restrains all components, a lock clutch lever 11 with an extended driven leg portion 11a that interfaces with both the actuator gear control lever drive feature 10b and the control lever 19, a lock clutch spring 12 that is retained in the lock clutch lever 11 and which an extended leg 12a interfaces with the lock lever 13 and controls the position thereof, and a lock lever spring 21 that applies a force to the lock lever 13 to bias the lock lever 13 in position 1 or position 2.

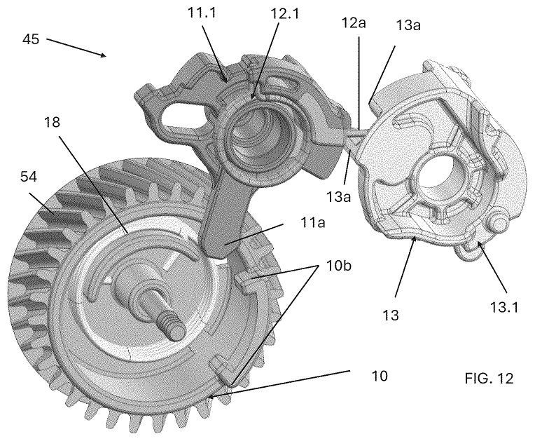

Referring now to FIG. 12, the lock control system 45 and lock clutch spring detail of the vehicle latch or vehicle latch assembly in accordance with the present disclosure is illustrated. Here the actuator gear 10 is in position (0) and the lock clutch lever 11 is in position 1 and the lock lever 13 is in position 1 and the control lever 19 (not shown in FIG. 12) is in position 2.

As illustrated, the lock clutch lever 11 interfaces with both the actuator gear control lever drive feature 10b and the control lever 19. The lock clutch spring 12 is retained in the lock clutch lever 11 and which the extended leg 12a interfaces with the lock lever 13 at spring contacts 13a and controls the position thereof. The lock lever spring 21 applies a force to the lock lever 13 to bias the lock lever into position 1 or position 2.

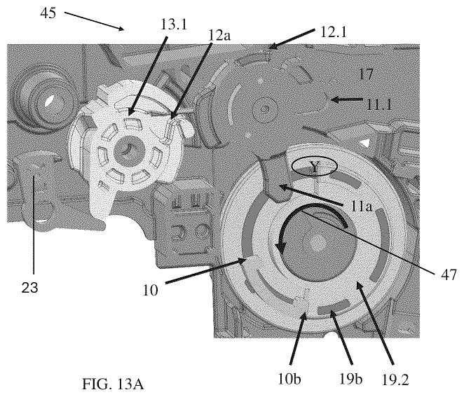

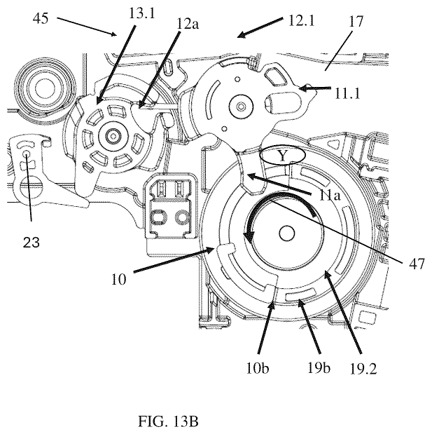

Referring now to at least FIGS. 13A and 13B, the lock control system 45 and method of operation of the vehicle latch or vehicle latch assembly in accordance with the present disclosure is illustrated. FIGS. 13A and 13B illustrate the beginning or start of a release event. Here the actuator gear 10 is driven from position 0 (home) towards position 1 (release position) and the actuator gear control lever drive feature 10b makes contact with control lever driven feature 19b and the control lever driving towards the lock clutch driven leg 11a illustrated by circle (Y). Note only features 10b of the actuator gear 10 is illustrated in FIGS. 13A and 13B. The rotational movement of actuator gear 10 and control lever 19 is illustrated by arrow 47. The lock clutch lever 11 is in position 1 identified as 11.1 and the lock clutch spring 12 is in position 1 identified as 12.1 and the lock lever 13 is in position 1 identified as 13.1 and the control lever 19 is in position 2 identified as 19.2.

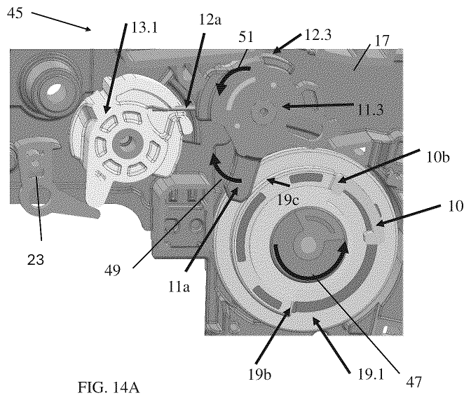

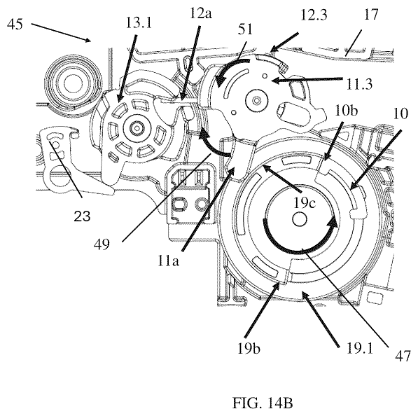

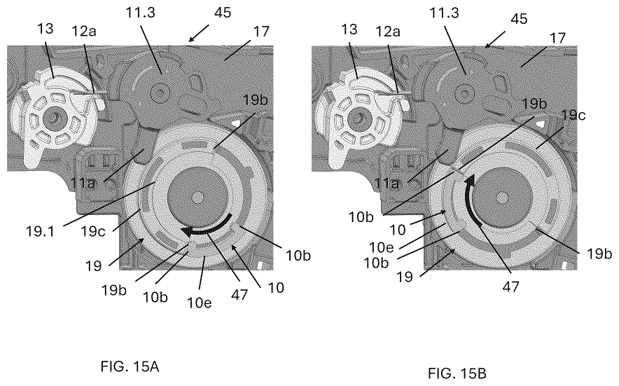

Referring now to at least FIGS. 14A and 14B, the lock control system 45 and method of operation of the vehicle latch or vehicle latch assembly in accordance with the present disclosure is illustrated. Here, the actuator gear 10 has now been driven to position 1 (release position) or final position until the control lever 19 is stalled against its associated stop surface 17a integrated into the housing 17 (see FIGS. 7-7F). Note only features 10b of the actuator gear 10 is illustrated in FIGS. 14A and 14B. The rotational movement of actuator gear 10 and control lever 19 is illustrated by arrow 47. The lock clutch lever 11 is now in position 3 identified as 11.3 and the lock clutch spring 12 is in position 3 identified as 12.3 and the lock lever 13 is in position 1 identified as 13.1 and the control lever 19 is in position 1 identified as 19.1.

The control lever driven feature 19b contacts and pushes the lock clutch driven leg 11a to its bypass position 11 identified as 11.3 (this movement is illustrated by arrow 49) and the lock clutch lever 11 is held in this bypass position by means of a control lever cam face 19c which extends along the periphery between features 19b of the control lever 19 and the lock clutch spring 12 is compressed to its bypass identified as position 12.3 applying a torque upon the lock clutch 11.3 in the direction of arrow 51.

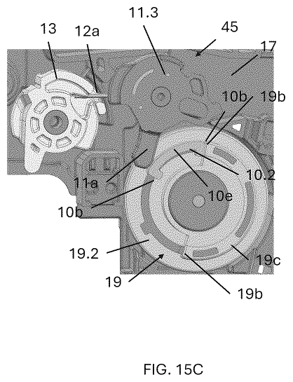

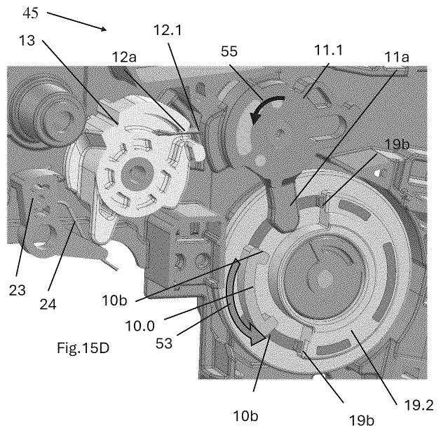

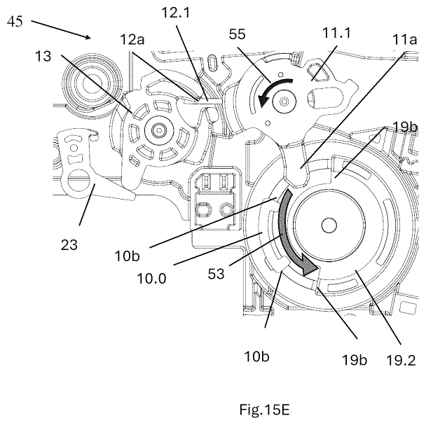

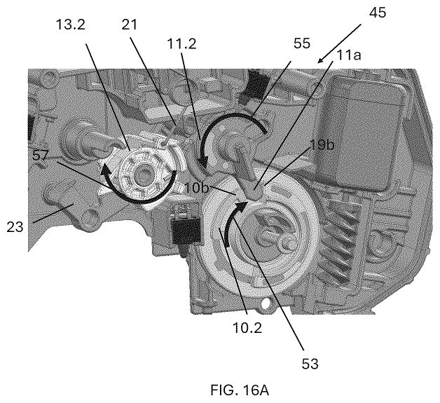

Referring now to at least FIGS. 15A-15C, the release return event of the lock control system 45 is illustrated.

In FIG. 15A, the actuator gear 10 is driven electrically from position 1 shown in at least FIGS. 14A-14B by the motor assembly 15 and makes contact with the control lever feature 19b opposite to the control lever feature 19b used to drive the control lever position illustrated in at least FIGS. 14A and 14B. In other words, once the motor assembly 15 causes gear 10 to reach the release position 1 it will return gear 10 to position 2 after position 1 is reached. Note only features 10b of the actuator gear 10 is illustrated in FIGS. 15A-15C. The rotational movement of actuator gear 10 and control lever 19 is illustrated by arrow 47.

In FIG. 15A, the control lever 1 is in position 1 identified as 19.1. In FIG. 15B, the actuator gear 10 is driven electrically towards position 2 by the motor assembly 15 here the lock clutch lever 11 is in position 3 identified as 11.3 and the lock clutch driven leg 11A is nearing end of support the by control lever cam face 19c and the control lever 19 is driven towards position 2, reaching a transition point at the end of control lever cam face 19c.

In FIG. 15C, the actuator gear 10 is reaching position 2 identified as 10.2 and the control lever 19 is in position 2 identified as 19.2 and the lock clutch lever 11 is in position 3 identified as 11.3 and the lock clutch driven leg 11a transitions from control lever cam face 19c to an actuator gear cam face 10e which extends along the periphery between features 10b of the actuator gear 10.

In FIGS. 15D and 15E, the actuator gear 10 upon reaching position 2, the motor power is removed and the gear return spring 18 applied torque illustrated by arrow 53 returns the gear 10 to its home position (0) identified as 10.0 and as described in at least FIGS. 8-10C. As illustrated, the control lever 19 now remains in position 2 identified as 19.2 and the lock clutch lever 11 transitions to position 1 identified as 11.1 and the lock clutch driven leg 11A transitions from the actuator gear cam face 10e back to position 1 identified as 11.1 via stored energy (illustrated by arrow 55) in the lock clutch lever spring 12, also returning to position 1 identified as 12.2. As such, the lock clutch driven leg 11a is now located in a gap between one of the control lever features 19c and one of the actuator gear features 10b.

Referring now to FIGS. 16A and 16B an unlock event of the lock control system 45 is illustrated. Here the actuator gear 10 is driven in the direction of arrow 53 towards position 2 from position 0 of the actuator gear 10, contacting and driving in the direction of arrow 55 the lock clutch lever extended leg 11a via the feature 10b of the actuator gear 10 until the motor assembly 15 stalls when the lock clutch lever extended leg 11a is trapped in series with the control lever feature 19c and the feature 10b of the actuator gear 10. Note only features 10b of the actuator gear 10 is illustrated in FIGS. 16A-16B. The lock clutch spring 12 that is retained in the lock clutch lever 11 and which extended leg 12a interfaces with the lock lever 13 drives the lock lever 13 in the direction of arrow 57 and the lock lever transitions to its position 2 identified as 13.2. A lock lever spring 21 (shown in at least FIG. 3) applies force to the lock lever 13 to bias the lock lever in position 2.

Referring now to FIGS. 16C and 16D movement of the actuator gear to the home position after an unlock event is illustrated, the actuator gear 10, upon reaching position 2 as described in FIGS. 16A and 16B, and after motor power off, will then return to position (0), the home position, by means of the gear return spring applied torque as described in FIGS. 8A-10C and illustrated by arrow 43. The control lever 19 now remains in position 2 labeled as 19.2. The lock clutch lever 11 and lock lever 13 now remain in position 2 labeled as 11.2 and 13.2 respectively due to the applied force of the lock lever spring 21 biasing pressure.

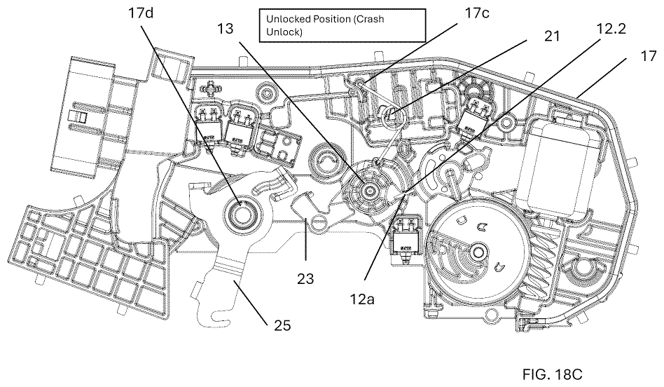

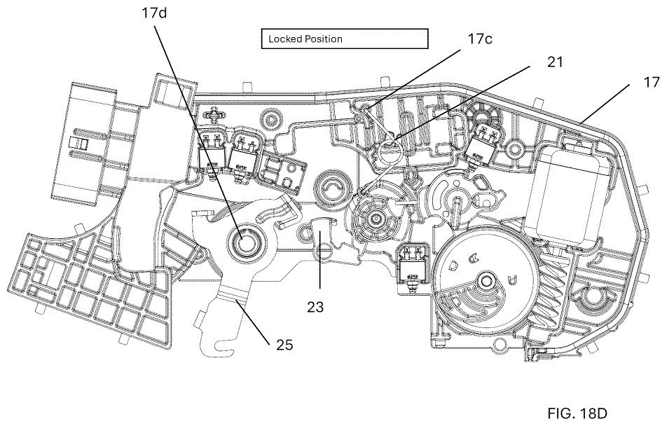

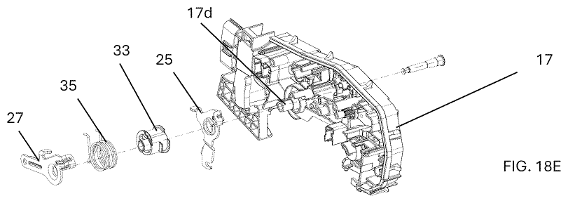

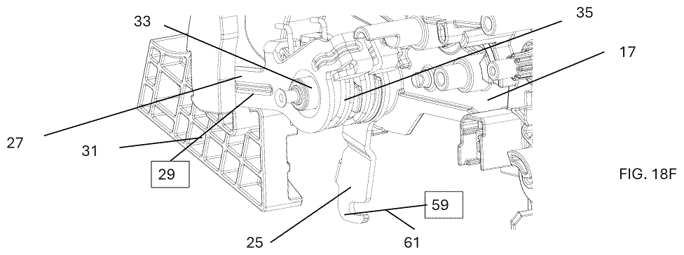

In at least FIGS. 16E-16I, the lock control system 45 and method thereof and a lock lever stop detail is illustrated. As illustrated, a lock lever stop damper 22 is positioned and retained by an integrated feature 17b in the actuator housing 17. The lock lever stop damper 22 may be formed of a rubber or elastomeric material. The lock lever spring 21 is positioned and retained by an integrated feature 17c (see at least FIGS. 18E and 18F) in the actuator housing 17. In FIG. 16E, the lock lever 13 is in position 1 labeled as 13.1 and the lock clutch lever 11 is in position 1 labeled as 11.1. This corresponds to the lock position of the lock control mechanism 45 wherein operation of an outside release lever 25 of the vehicle latch 1 will not cause the vehicle latch 1 to open. FIG. 16F is an opposite view of the lock lever 13, the lock clutch lever 11 and the actuator lever 19 illustrated in FIG. 16E. Also shown in FIG. 16F is the lock lever stop damper 22. Also shown are lock lever stop features 13b.

In FIG. 16F, the lock control system 45 is in the unlock position wherein operation of an outside release lever 25 of the vehicle latch 1 will cause the vehicle latch 1 to open. In FIG. 16F, the lock lever 13 is in position 2 labeled as 13.2 and the lock clutch lever 11 is in position 2 labeled as 11.2. This corresponds to the unlock position of the lock control mechanism 45. FIG. 16H is an opposite view of the lock lever 13, the lock clutch lever 11 and the actuator lever 19 illustrated in FIG. 16G. Also shown in FIG. 16F is the lock lever spring cam feature 13c configured to make contact with the lock lever spring 21 as the lock lever 13 rotates.

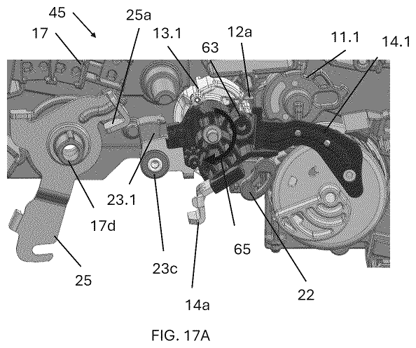

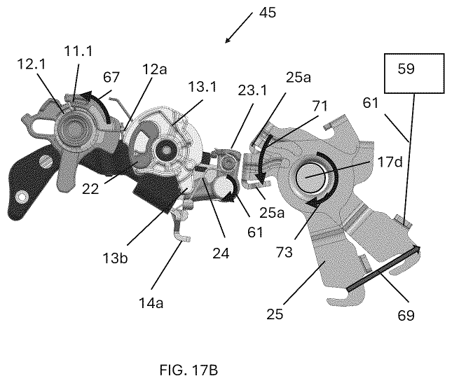

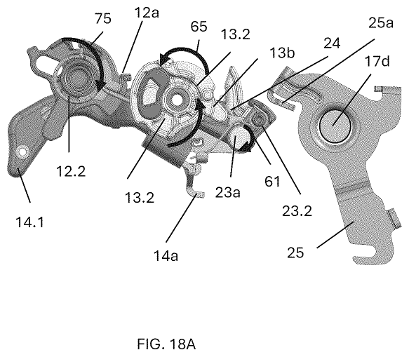

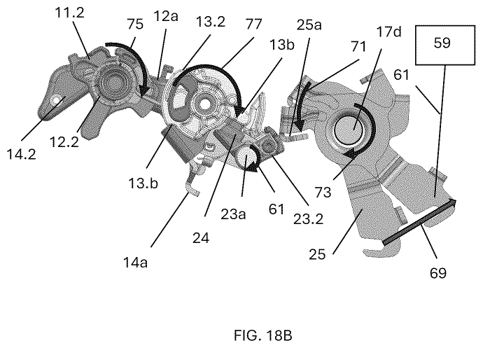

Referring now to at least FIGS. 17A and 17B, the lock control system 45 and method thereof and a bypass lever functionality thereof is illustrated. FIG. 17B is an opposite view of the view illustrated in FIG. 17A without the actuator housing 17. Illustrated in at least FIGS. 17A and 17B is an outside release lever 25 that is rotationally mounted to the actuator housing 17. In one embodiment, the outside release lever 25 is mounted to a feature 17d of the actuator housing 17. The outside release lever 25, which is pivotally mounted to the vehicle latch or latch assembly 1 is affected by operation of an outside handle 59 operably coupled to the outside release lever 25 by a linkage 61 such as a cable or rod or any other equivalent structure. Also shown is a bypass lever 23 that is rotationally mounted to the release lever 14. The position of the bypass lever 23 will determine whether the rotational movement of the outside release lever 25 will cause the vehicle latch 1 to be opened. In a locked state of the vehicle latch 1, the bypass lever 23 will not be contacted by the outside release lever 25 and thus no movement of the outside release lever will be translated to the bypass lever. This locked state is illustrated in at least FIGS. 17A and 17B.

In FIGS. 17A and 17B, the actuator gear 10 is in position 0 identified as 10.0 and the lock clutch lever 11 is in position 1 identified as 11.1. In addition, the lock clutch spring 12 is in position 1 identified as 12.1 and the lock lever 13 is in position 1 identified as 13.1. The bypass lever 23 is in position 1 identified as 23.1. The bypass lever 23 is pivotally mounted to the release lever 14 by a pivot 23c. Also shown is a bypass spring 24 for providing a biasing force to the bypass lever 23. The bypass spring 24 provides a biasing force in the direction of arrow 61 to position 2 of the bypass lever 23 identified as 23.2 when the bypass lever is in position 1. Also shown is a release lever spring 63 for providing a biasing force in the direction of arrow 65 in order to bias or return the release lever 14 to position 1. The release lever 14 is in position 1 identified as 14.1 in FIGS. 17A and 17B.

The lock clutch spring 12 that is retained in the lock clutch lever 11 and which an extended leg 12a of the lock clutch spring 12 interfaces with the lock lever 13 and drives the lock lever 13 in the direction of arrow 67 to its position 1 illustrated as 13.1. The lock lever spring 21 applies force to the lock lever 13 to bias the lock lever in position 1. The release lever also pivots concentrically on the lock lever pivot 20. Thus, the release lever 14 and the lock lever 13 pivot about the same axis. Also shown is the bypass lever 23 that is in position 1 illustrated by 23.1 that pivots on an eccentric location 23c of the release lever 14. In other words, the bypass lever 23 pivots on the release lever 14 and contact with the bypass lever 23 by the outside release lever 25 will rotate the release lever 14. Movement of the bypass lever 23 with respect to the release lever 14 is effected by a cam lobe 13b integrated into the lock lever 13, and bypass lever 23 is spring biased by the bypass lever spring 24 in direction of arrow 61. Also, shown is that when the outside release lever 25 is acted up by a linear force in the direction of arrow 69 will cause rotation of the outside release lever 25 about its pivot 17d in the direction of arrow 71. The outside release lever 25 may be operably coupled to an outside handle 59 via a cable, rod or other equivalent device 61 for operation of the latch 1 in order to provide the linear force in the direction of arrow 69.

The outside release lever 25 also has a lever contact feature 25a that will not contact the bypass lever 23 when it is in position 1 (locked) and identified as 23.1. The outside release lever 25 is spring biased to return to its home position in the direction of arrow 73.

Referring now to at least FIGS. 18A-18F, the lock control system 45 and method thereof and bypass lever functionality is illustrated. In at least FIGS. 18A, 18B and 18C, the lock control system 45 is in an unlocked state such that rotational movement of the outside release lever 25 will be transferred to the release lever 14 via bypass lever 23 and the latch 1 will be opened. As illustrated in at least FIGS. 18A, 18B and 18C, the lock clutch spring 12 is in position 2 labeled as 12.2 and the lock clutch spring is retained in the lock clutch lever 11 which is in position 2 illustrated by 11.2 and which an extended leg 12a thereof interfaces with the lock lever 13, which is in position 2 illustrated as 13.2 and drives the lock lever 13 to its position 2 in the direction of arrow 75. The lock lever spring 21 applies force to the lock lever 13 to bias the lock lever 13 into position 2 illustrated as 13.2. The release lever 14 pivots concentrically on the lock lever pivot 20 and is spring biased in direction arrow 65 into the position 1 illustrated as 14.1. The bypass lever 23 that pivots on the eccentric location 23a of the release lever 14 and the bypass lever 23 is positioned by a cam lobe 13b integrated into the lock lever 13, which is spring biased by the bypass lever spring 24 in direction of arrow 61. Thus, as the lock lever 13 rotates to its position 2, illustrated as 13.2 and the bypass lever 23 is allowed to rotate (via spring torque in the direction of arrow 61) to its position 2 illustrated as 23.2. In this position the lock mechanism 45 is in an unlocked position so that the outside release lever 25 may open the latch 1.

In the unlocked position illustrated in at least FIGS. 18A, 18B and 18C, the outside release lever 25 which when acted up by a linear force in the direction of arrow 69 will cause rotation of the outside release lever about its pivot 17d that is integrated into the actuator housing 17, in the direction of arrow 71.

The outside release lever 25 also has a lever contact feature 25a that will contact the bypass lever 23 when it is in position 2 illustrated as 23.2 and cause relative rotational motion in the direction of arrow 77 to the release lever 14 when it is contact by the lever contact feature 25a as the outside release lever 25 is rotated in the direction of arrow 71 until it has reached position 2 illustrated as 14.2. The outside release lever 25 is spring biased to return to its home position in the direction of arrow 73.

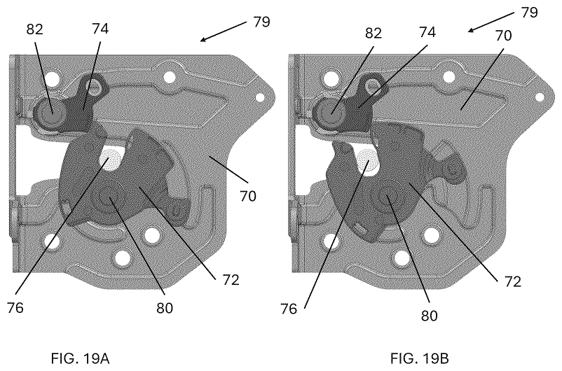

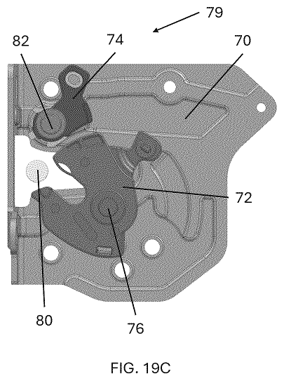

The release lever 14 has an integral contact feature 14a which causes the vehicle latch 1 to open when the release lever 14 is moved to position 2. This operation will be described with respect to at least FIGS. 19A-21B described below.

FIG. 18D illustrates the lock control system 45 is in a locked state such that rotational movement of the outside release lever 25 will not be transferred to the release lever 14 via bypass lever 23 and the latch 1 will not be opened.

FIG. 18E is an exploded view illustrating the mounting of the outside release lever 25 and an inside release lever 27 to the housing 17. As mentioned above, the outside release lever 25 is be operably coupled to an outside handle 59 via a cable, rod or other equivalent device 61 in order to rotate outside release lever 27 for operation of the latch 1. In addition, the inside release lever 27 is be operably coupled to an inside handle 29 via a cable, rod or other equivalent device 31 in order to rotate the inside release lever 27 for operation of the latch 1. As illustrated, the outside release lever 25 pivots on the actuator housing 17 and the inside release lever 27 pivots on a spring mandrel component 33 and a spring 35 is provided to provide a biasing force to the outside release lever 25 and the inside release lever 27 to return them to their unactuated position (e.g., not actuated by the outside handle 59 or the inside handle 29.

Referring now to FIGS. 19A-19C, portions of a retention system 79 of the vehicle latch or vehicle latch assembly 1 in accordance with the present disclosure. Here a backing plate 70 is illustrated with a claw 72 and pawl 74 rotationally secured thereto. The backing plate 70 is secured to a housing 2a of the latch 1. The claw 72 and a pawl 74 are pivotally secured to the backing plate 70 as is known in the related arts. The claw 72 is pivotally or rotationally mounted to the backing plate 70 for movement between a latched position wherein a striker 76 of a vehicle the latch 1 is secured to is retained by the vehicle latch 1 and an unlatched position wherein the striker 76 is released from the vehicle latch. The pawl 74 is also pivotally or rotationally secured to the backing plate 70 for movement between an engaged position wherein the pawl retains the claw 72 in the latched position or a partially latched or secondary position and disengaged position wherein the pawl 74 no longer retains the claw 72 in the latched position or a partially latched or secondary position such that the claw 72 can rotate or pivot into the unlatched position. The partially latched or secondary position of the claw 72 is located between the unlatched position and the latched position as is known in the related arts.

In FIG. 19A, the claw 72 is in a primary or latched position where a striker 76 is retained by the claw 72 and the pawl 74 is an engaged position. The striker 76 is typically mounted to a stationary structure (e.g., door frame) of a vehicle the latch 1 is secured to. In FIG. 19B, the claw 72 is in a secondary or latched position where the striker 76 is still retained by the claw 72 and the claw 72 is still retained by the pawl 74 however, the claw has rotated partially towards an open or unlatched position and the pawl 74 is still in an engaged position. This may be referred to as a “door ajar position” (e.g., the vehicle door is slightly opened but still retained by the latch. In FIG. 19C, the pawl 74 has been rotated into a disengaged position where it no longer retains the claw 72 and the claw 72 is free to rotate into the open position illustrated in FIG. 19C and the striker 76 is released from the latch 1. The claw 72 is spring biased into the open position and the pawl 74 is spring biased into the engaged position as is known in the related arts.

FIGS. 20A and 20B illustrate a pawl release lever 78 of the retention system 79 for moving the pawl 74 from the engaged position FIGS. 19A, 19B and 20A to the disengaged position FIGS. 19C and 20B. The pawl release lever 78 has a feature 78a that engages and rotates the pawl 74 from the engaged position to the disengaged position as the pawl release lever is rotated in the direction of arrow 81. The pawl release lever 78 also has a feature 78b that is configured to be engaged by the integral contact feature 14a of the release lever 14 as it is rotated into position 2 either through actuation of the release gear 10 through a power release operation when the motor 50 rotates the gear 10 into position 2 and the cam feature 10a rotates the release lever 14 into position 2 (see at least FIG. 5). As mentioned above, this position causes integral contact feature 14a of the release lever 14 to contact feature 78b and rotate the pawl release lever in the direction of arrow 81 and cause the pawl 74 to rotate in the direction of arrow 81 to the disengaged position. Alternatively, the movement of the release lever 14 into position 2 can be achieved through actuation of the outside release lever 25 in the direction of arrow 71 via application of a force in the direction of arrow 69 when the lock control system 45 is in an unlocked state as described above and illustrated in at least FIGS. 16A, 16B, 18A and 18B such that rotational movement of the outside release lever 25 will be transferred to the release lever 14 via bypass lever 23 and the latch 1 will be opened by rotating the pawl 74 into the disengaged position.

FIGS. 21A and 21B illustrate the release lever 14 interface or retention system release process for moving the pawl 74 from the engaged position to the disengaged position. Also shown in at least FIGS. 19A-21B are pivots 80 and 82 for the rotational mounting of the claw 72, pawl 74 and pawl release lever 78 to the backing plate 70 and the latch 1.

As mentioned above, the vehicle latch or vehicle latch assembly 1 uses only the single motor 50 to perform both an electrical release and crash unlock function. During the electrical release or power release operation the motor 50 rotates the gear 10 into position 2 and the cam feature 10a rotates the release lever 14 into position 2 (see at least FIG. 5). As mentioned above, this position causes integral contact feature 14a of the release lever 14 to contact feature 78b and rotate the pawl release lever in the direction of arrow 81 and cause the pawl 74 to rotate in the direction of arrow 81 to the disengaged position, which in turn opens the latch 1. The same motor is used to automatically unlock the latch 1 so that an outside handle 59, when actuated will also rotate the release lever 14 into position 2 (see at least FIG. 5). As mentioned above, this movement of the outside handle 59 when the lock control system 45 is in the unlock position (see at least FIG. 16F), wherein operation of an outside release lever 25 of the vehicle latch 1 will cause the vehicle latch 1 to open since the aforementioned movement of the outside release lever causes integral contact feature 14a of the release lever 14 to contact feature 78b and rotate the pawl release lever in the direction of arrow 81 and cause the pawl 74 to rotate in the direction of arrow 81 to the disengaged position, which in turn opens the latch 1.

Operation of the motor 50 to perform the power release of the latch 1 or to place the lock control system 45 of the vehicle latch 1 automatically in the unlock position is in one non-limiting embodiment is achieved by a controller, microprocessor, microcontroller or other equivalent processing device 83 operably coupled to the motor 50 and a plurality of sensors 85 at least one of which is configured to detect a crash event of the vehicle the latch 1 is associated with in order to independently and automatically unlock the latch 1 so that an outside handle 59, when actuated will also rotate the release lever 14 into position 2 (see at least FIG. 5). The unlocking function may be referred to “crash unlock”. As such, and in one embodiment the location of the pawl 74 on the vehicle latch or vehicle latch assembly 1 ensures proper performance during an unfortunate crash event.

The controller, microprocessor, microcontroller or other equivalent processing device 83 is capable of executing commands of computer readable data or program for executing a control algorithm that controls the operation of the motor 50 to perform at least the aforementioned “crash unlock” and power release operations with the single motor 50. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include input signal filtering to enable accurate sampling and conversion or acquisitions of such signals from communications interfaces.

The controller, microprocessor, microcontroller or other equivalent processing device 83 and sensors 85 may be integral to the latch 1 or alternatively remote to the latch 1 or a combination thereof remote and/or integral.

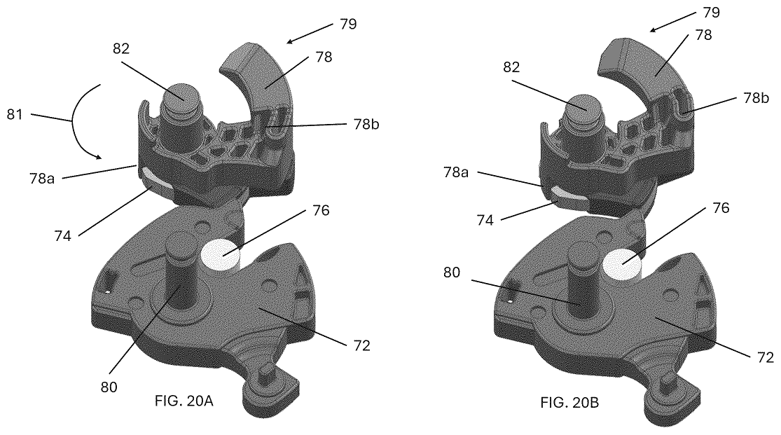

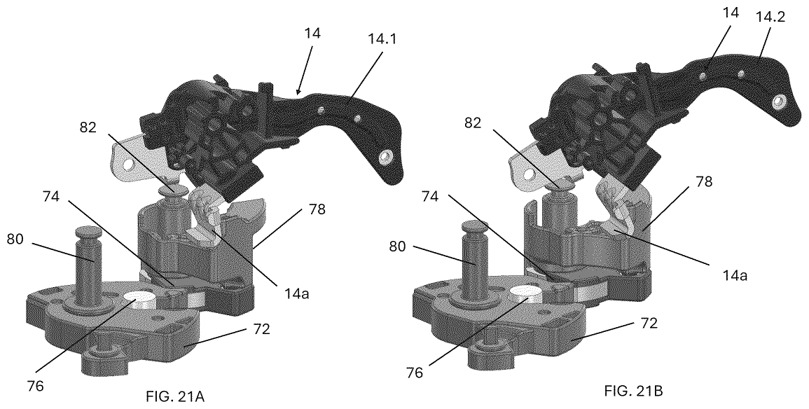

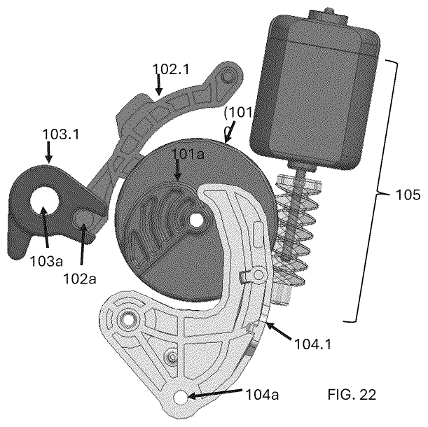

Referring now to FIGS. 22-33C, an alternative configuration of an actuator 4 for the vehicle latch is illustrated. Illustrated in at least FIG. 22 is an actuator gear 101 in a position 0 (neutral position) identified as 101.0, an actuator gear cam face 101a, a drive link 102 in position 1 identified as 102.1, a cam lever 103 in position 1 identified as 103.1, a cam follower 104 in position 1 identified as 104.1, and an actuator motor assembly 105. The actuator of FIGS. 22-33C can also provide the aforementioned two control functions power release and crash unlock. For example, movement of the cam follower 104 will cause the pawl 74 to be moved to the disengaged position during power release and movement of the cam lever 103 will place the latch 1 in an unlocked state such that movement of an outside handle will cause the vehicle latch 1 to open since the aforementioned movement of the outside release lever causes the pawl to rotate into the disengaged position, which in turn opens the latch 1.

The actuator drive system 105 includes a motor for rotating a worm gear and a mating gear 101 that has a cam face 101a integrated into one side. In FIG. 22, the gear 101 is in the neutral position 0 identified as 101.0 and the cam lever 104 is in position 1 identified as 104.1 that is rotatable about a pivot 104a and follows the actuator gear cam face 101a during a power release function. The drive link 102 is in position 1 identified as 102.1 that interfaces with the actuator gear 101 opposite the cam side shown in FIG. 22 and the cam lever 103 is in position 1 identified as 103.1 at interface 102a between the drive link 102 and the cam lever 103. The cam lever 103 is rotatable about a pivot 103a.

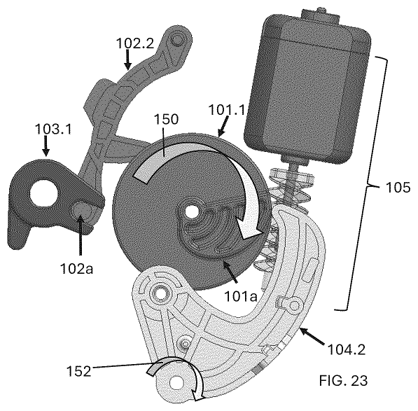

In FIG. 23 the actuator gear 101 is in position 1 identified as 101.1 driven from position 0 illustrated in FIG. 22 and the drive link 102 is in position 1 identified as 102.1 and cam lever 103 is in position 1 identified as 103.1 and the cam follower 104 is in position 2 identified as 104.2. The actuator gear 101 beginning from the neutral position 0 (illustrated in at least FIG. 22) is driven clockwise in the direction of arrow 150 to position 1 identified as 101.1 and cam face 101a drives the cam lever 104 in the direction of arrow 152 to a second position, position 2 identified as 104.2. The drive link 102 is driven to a bypass position, position 2 identified as 102.2 by features on opposite face of the actuator gear 101. The drive link 102 is also rotatable about an integrated pin at the interface with cam lever 103 at 102a. The cam lever 103 remains stationary during this phase of actuation in position 1 identified as 103.1.

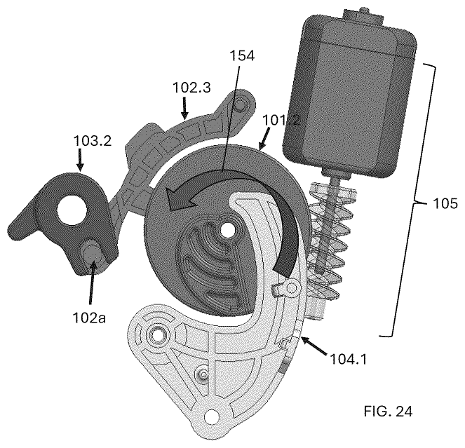

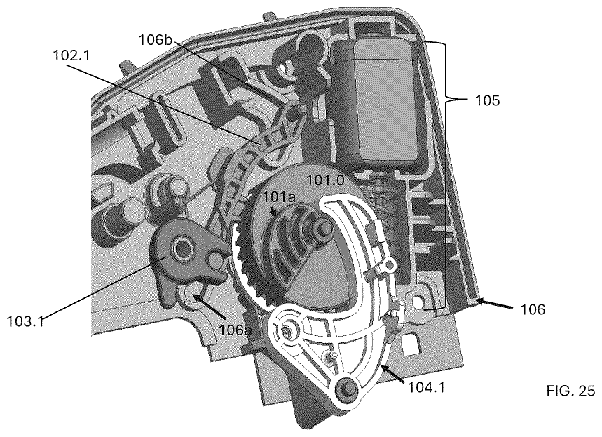

Referring now to at least FIG. 24, the actuator gear 101 beginning from the neutral position 0 illustrated in at least FIG. 22 is driven counter clockwise in the direction of arrow 154 to position 2 identified as 101.2. The drive link 102 is driven to another position, position 3 identified as 102.3 by features on opposite face of the actuator gear 101. The drive link 102 is also translatable along a guide channel 106b of the actuator housing 106 (see at least FIG. 25) constraining an integrated pin 102a opposite the interface with cam lever. The cam lever 103 is driven to position 2 identified as 103.2 by the drive link 102 when it is moved to the second position identified as 102.3.

FIG. 25 illustrates portions of the actuator housing 106 that positions and restrains all components. As illustrated, the housing has guide channels 106a, 106b integrated into the housing 106 that restrain and guide the drive link 102 to translate and rotate as described in at least FIGS. 23 and 24. In FIG. 25, the actuator gear 101 is in position 0 identified as 101.0 and the drive line is in position 1 identified as 102.1. The cam lever 103 is in position 1 identified as 103.1 and the cam follower is in position 2 identified as 104.1. Also shown is the actuator motor assembly 105 and the actuator gear cam face 101a is in position 1.

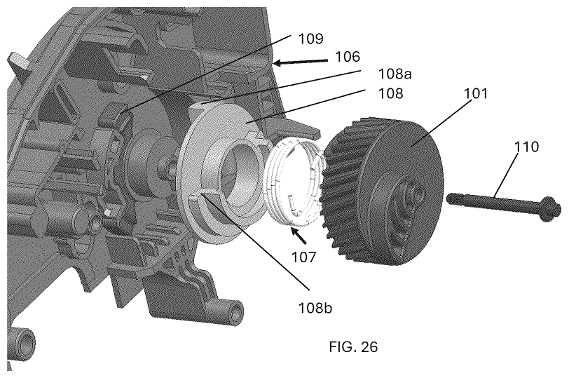

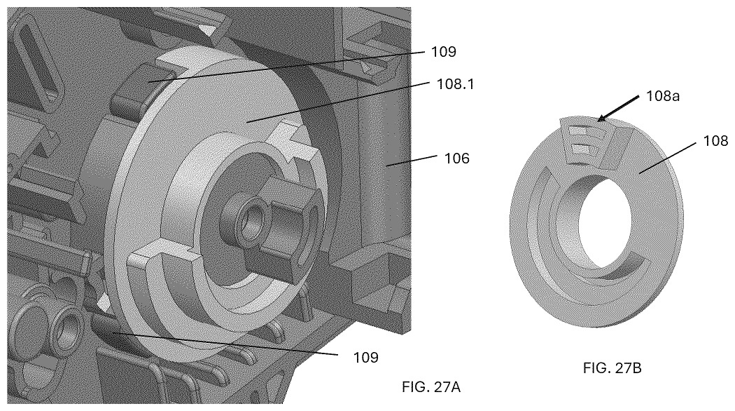

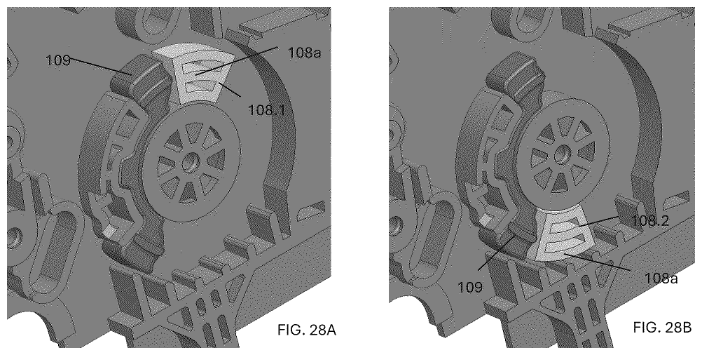

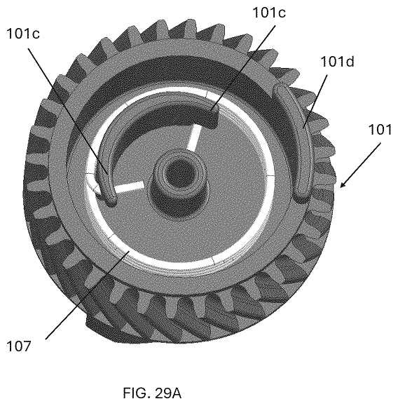

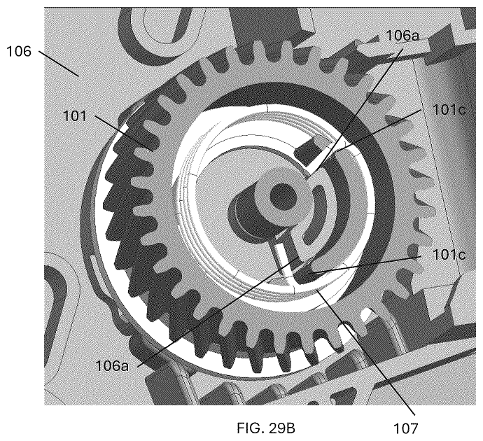

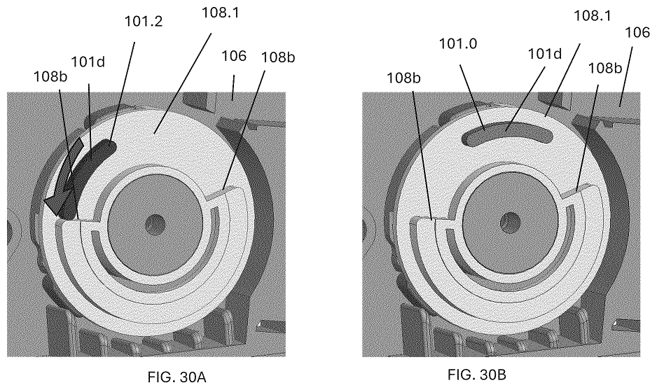

In at least FIG. 26, the actuator gear 101, an actuator return spring 107, a control lever 108, and an actuator pivot 110 are shown in an exploded view with respect to the actuator housing 106 and a stop bumper 109. The actuator pivot 110 is retained by the housing 106 and restrains the actuator gear 101 which pivots about the actuator pivot 110. The actuator return spring 107 acts upon the actuator gear 101 to return the actuator gear 101 to its neutral position from position 2 once the motor is de-energized. The actuator return spring 107 is also retained by the housing 106 to act as a static element. Additional details are illustrated in at least FIGS. 29A and 29B. The control lever 108 is driven by the actuator gear 101 and the end of travel of the control lever is controlled by the stop bumper 109 that that is positioned in the actuator housing 106. See the additional detail in at least FIGS. 27A-28B.

In FIGS. 27A and 27B, a portion of the actuator housing 106 is illustrated and the control lever 108 is in position 1 identified as 108.1. The control lever 108 has an integral travel end stop control feature 108a integrated into the control lever 108 that stops against the stop bumper 109 as the control lever 108 rotates within respect to housing 106. Additional features are illustrated in FIGS. 28A-28B.

FIGS. 28A and 28B are cross-sectional views of a portion of housing 106 and control lever 108. In FIG. 28A the control lever 108 is in position 1 identified as 108.1 wherein the feature 108a contacts stop bumper 109. In FIG. 28B the control lever 108 has been rotated to position 2 identified as 108.2 wherein the feature 108a contacts stop bumper 109 at an opposite location with respect to FIG. 28A.

FIG. 29A illustrates the actuator gear 101, an actuator return spring 107 and an actuator gear features 101c for retaining portions of the actuator return spring 107. Also shown are actuator gear features 101d for interfacing with the control lever 108 and the drive link 102.

FIG. 29B illustrates the actuator gear 101 position on the control lever 108 on the housing 106. Portions of the actuator gear 101 are shown in cross-section in particular the actuator gear retaining feature 101c.

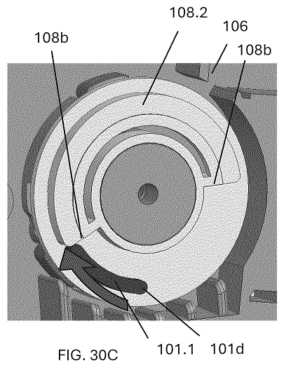

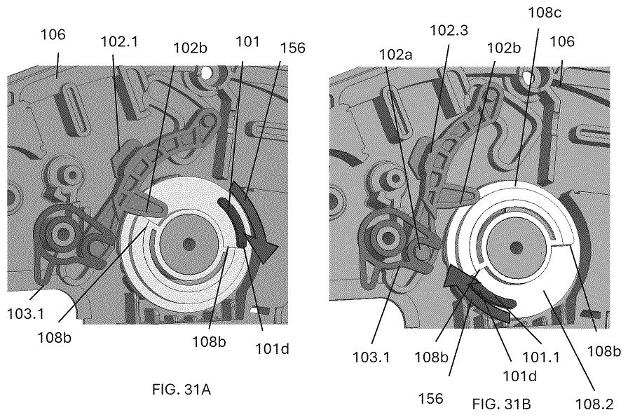

FIG. 30A illustrates the control lever 108 in position 1 identified as 108.1. Also shown are the control lever 108 driven features 108b and the actuator gear features 101d for interfacing with the control lever 108 and the drive link 102. Note in FIG. 30A only the actuator gear features 101d are illustrated corresponding to the actuator gear 101 in position 2 labeled as 101.2.

FIG. 30B illustrates the control lever 108 in position 1 identified as 108.1. Also shown are the control lever 108 driven features 108b and the actuator gear features 101d for interfacing with the control lever 108 and the drive link 102. Note in FIG. 30B only the actuator gear features 101d are illustrated corresponding to the actuator gear 101 in position 0 labeled as 101.0.

FIG. 30C illustrates the control lever 108 in position 2 identified as 108.2 driven there by the actuator gear 101. Also shown are the control lever 108 driven features 108b and the actuator gear features 101d for interfacing with the control lever 108 and the drive link 102. Note in FIG. 30C only the actuator gear features 101d are illustrated corresponding to the actuator gear 101 in position 1 labeled as 101.1.

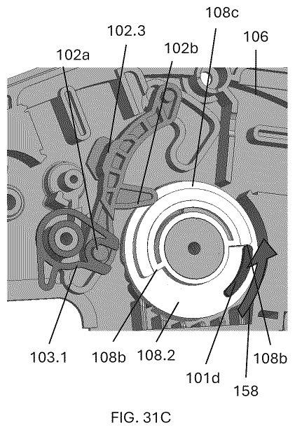

FIG. 31A illustrates the actuator gear 101 driven clockwise in the direction of arrow 156 by the motor from the neutral position 0 towards position 1. Note in FIG. 31A only the actuator gear features 101d are illustrated corresponding to the actuator gear 101. The features 101d contact the control lever 108 at one of the features 108b and the drive link 102 is driven to position 1 labeled 102.1 where leg or feature 102b of the drive link makes contact with the other feature 108b of the control lever 108 (e.g., the feature 108b that is not contacted by features 101d) as the control lever 108 is driven towards position 2 by the gear 101. The cam lever 103 is in position 1 labeled as 103.1.

In the FIG. 31B, the actuator gear 101 is driven to position 1 in the direction of arrow 156 labeled as 101.1. The feature 101d contacts feature 108b and the drive link 102 is held fixed at point 102a rotates to position 3 labeled as 102.3 via contact with feature 108b and held in position 3 via the drive link 102 driven face 102b and surface 108c of the control lever that extends between contact features 108b. The cam lever 103 is in position 1 labeled as 103.1 and the control lever 108 is in position 2 labeled as 108.2. Note in FIG. 31B only the actuator gear features 101d are illustrated corresponding to the actuator gear 101.

In at least FIG. 31C, the actuator gear 101 is driven clockwise by the motor in the direction of arrow 158 to position 2 labeled as 101.2. Note in FIG. 31C only the actuator gear features 101d are illustrated corresponding to the actuator gear 101. The drive link 102 is in position 3 labeled as 102.3 and the cam lever 103 is in position 1 labeled as 103.1 and the control lever is being driven toward position 2.

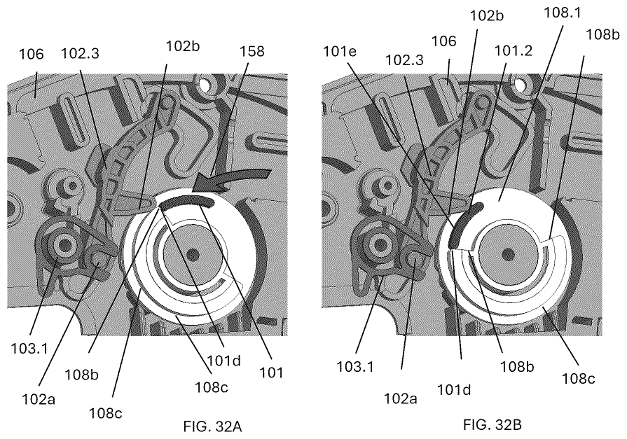

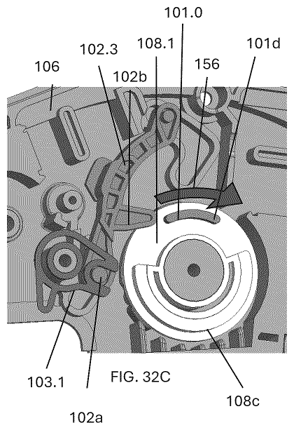

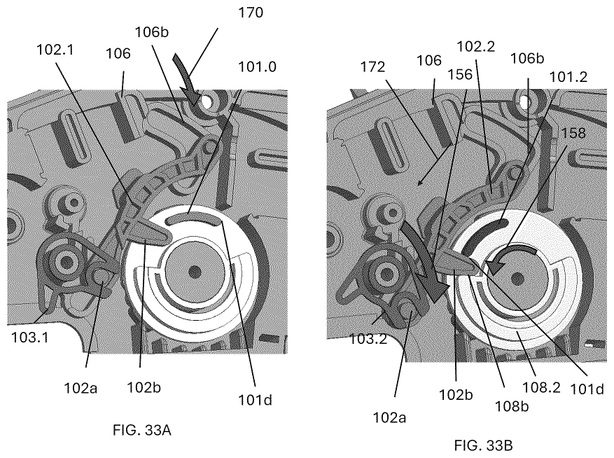

In at least FIG. 32A, the actuator gear 101 is being driven towards position 2 by the motor which also drives the control lever 108 in the direction of arrow 158 via contact of feature 101d with feature 108b position 2. The drive link 102 is in position 3 labeled as 102.3 and the cam lever 103 is in position 1 labeled as 103.1.

In at least FIG. 32B, the actuator gear 101 continues to drive counter clockwise in the direction of arrow 158 (FIG. 32A) to position 2 labeled as 101.2. The drive link 102 is held fixed at point 102a and transitions from the control lever surface 108c to the a peripheral surface 101e of feature 101d. The cam lever 103 is in position 1 labeled as 103.1 and the control lever 108 has been rotated into position 1 labeled as 108.1.

In at least FIG. 32C, the actuator gear has returned to position 0 or the neutral position labeled as 101.0 when the motor is de-energized via the biasing force of return spring 107 (see at least FIG. 26) and the control lever 108 remains in position 1 labeled as 108.1 as its position here is independent of the actuator gear 101. Note in FIGS. 31A-31C only the actuator gear features 101d are illustrated corresponding to the actuator gear 101.

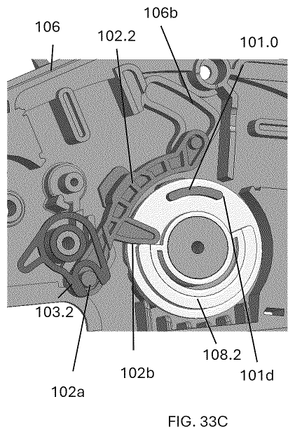

In at least FIG. 33A, the drive link 102 is held at point 102a rotates back to position 1 labeled as 102.1 since impediment has been removed and feature 102b can be positioned within a gap between features 101d and 108b and the portion of the drive link 102 received in channel 106b moves in the direction of arrow 170.

In at least FIG. 33B, the actuator gear 101 is driven counter clockwise in the direction of arrow 158 by motor from the neutral position 0 to position 2 labeled as 101.2 as this occurs with feature 102b positioned within the gap between features 101d and 108b and feature 101d will contact feature 102b and cause the drive link 102 to translate in the direction of arrow 172 to position 2 labeled 102.2 by sliding within channel 106b. This movement will cause rotation of the cam lever 103 in the direction of arrow 156 to position 2 labeled as 103.2 since the cam lever 103 is rotatably secured to the housing 106 and feature 102a is received within cam lever 103. Position 2 of the cam lever 103 may be referred to as an unlock position wherein movement or actuation of an outside handle operably coupled to an outside release lever of the power side door latch 1 will open the latch as described above with respect to FIGS. 1-21B.

In at least FIG. 33C, the actuator gear 101 returns to the neutral position 0 labeled as 101.0 when motor is de-energized via the biasing force of return spring 107. The control lever 108 remains in position 2 since when the actuator gear 101 returns to the neutral position 0 when motor is de-energized via the biasing force of return spring 107 the control lever's position is independent of the movement of the actuator gear when it returns to the home position 0 from position 2 due to the biasing force of spring 107.

Note in FIGS. 33A-33C only the actuator gear features 101d are illustrated corresponding to the actuator gear 101.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A vehicle latch (1), comprising:
an actuator (4), the actuator including: an actuator gear (10) and a single motor (50), the single motor (50) rotates the actuator gear (10) about an axis in a first direction from a home position to a release position and a second direction opposite to the first direction from either the release position or only from the home position to a second position, wherein rotation of the actuator gear (10) to the release position opens the vehicle latch (1) and rotation of the actuator gear (10) from only the home position to the second position unlocks the vehicle latch such that operation of an outside release lever will open the vehicle latch (1).

2. The vehicle latch (1) as in claim 1, wherein the actuator gear (10) includes a cam face (10a) integrally formed with the actuator (10) for contacting a release lever (14) when the actuator gear (10) is rotated into the release position.

3. The vehicle latch (1) as in claim 1, wherein the single motor (50) drives a worm (52) that meshingly engages teeth (54) of the actuator gear (10).

4. The vehicle latch (1) as in claim 1, wherein the actuator (4) further comprises: a lock clutch lever (11); a lock lever (13); a release lever (14); a control lever (19); each rotatably mounted to a housing (17) of the actuator (4), the control lever (19) and the actuator gear (10) rotatably mounted the axis, and an actuator return spring (18) located between the control lever (19) and the actuator gear (10) and providing a biasing force between the control lever (19) and the actuator gear (10) when the actuator gear (10) is rotated with respect to the control lever (19).

5. The vehicle latch (1) as in claim 4, wherein the control lever (19) has a feature (19a) that limits rotation of the control lever (19) with respect to the actuator housing (17) as the control lever (19) rotates with respect to the actuator housing (17) and the feature (19a) contacts a feature (17a) of the actuator housing (17).

6. The vehicle latch (1) as in claim 5, wherein the control lever (19) has a feature (19b) that contacts a feature (10d) of the actuator gear (10) when the actuator gear (10) rotates with respect to the control lever (19).

7. The vehicle latch (1) as in claim 4, wherein one end of the actuator return spring (18) is retained by a feature (17a) of the actuator housing (17) and another end is retained by a feature (10c) of the actuator gear (10).

8. The vehicle latch (1) as in claim 4, wherein rotation of the actuator gear (10) in first direction does not apply a force to the actuator return spring (18) and rotation of the actuator gear (10) in the second direction to the second position from the home position applies a force to the actuator return spring that causes the actuator spring (18) to spring bias the actuator gear (10) into the home position from the second position.

9. The vehicle latch (1) as in claim 4, wherein the lock clutch lever (11) has a leg (11a) that is positioned between feature (10b) of the actuator gear (10) and feature (19b) of the control lever (19) when the actuator gear (10) is in the home position and the control lever (19) is in the second position.

10. The vehicle latch (1) as in claim 9, wherein the feature (10b) contacts the leg (11a) and rotates the lock clutch lever (11) when the actuator gear (10) is rotated from the home position in the second direction and the control lever is in the second position.

11. The vehicle latch (1) as in claim 10, wherein rotation of the lock clutch lever (11) by feature (10b) when the actuator gear (10) is rotated from the home position in the second direction and the control lever (19) is in the second position causes rotation of the lock lever (13) operably coupled to the lock clutch lever (11) which causes rotation of a bypass lever (23) rotatably mounted to the release lever (14), a position of the bypass lever (23) determines whether rotational movement of the outside release lever (25) will cause the vehicle latch (1) to be opened.

12. The vehicle latch (1) as in claim 1, wherein the actuator gear (10) includes a cam face (10a) integrally formed with the actuator (10) for contacting a release lever (14) when the actuator gear (10) is rotated into the release position and the single motor (50) drives a worm (52) that meshingly engages teeth (54) of the actuator gear (10).

13. The vehicle latch (1) as in claim 12, wherein a control lever (19) is rotatably secured to an actuator housing (17) and the control lever (19) has a feature (19a) that limits rotation of the control lever (19) with respect to the actuator housing (17) as the control lever (19) rotates with respect to the actuator housing (17) and the feature (19a) contacts a feature (17a) of the actuator housing (17).

14. The vehicle latch (1) as in claim 13, wherein the control lever (19) has a feature (19b) that contacts a feature (10d) of the actuator gear (10) when the actuator gear (10) rotates with respect to the control lever (19), the feature (19b) being on one side of the control lever (19) and the feature (19a) is located on an opposite side of the control lever (19).

15. The vehicle latch (1) as in claim 1, further comprising:
a lock control system (45) that is placed into an unlock condition when the actuator gear (10) is rotated only the home position to the second position.

16. The vehicle latch (1) as in claim 1, wherein the actuator gear (10) is spring biased into the home position from the second position.

17. The vehicle latch (1) as in claim 1, wherein after the actuator gear (10) is rotated into the release position, the actuator gear (10) is then rotated into the second position by the single motor wherein movement of the actuator gear (10) directly from the release position to the second position does not unlock the vehicle latch such that operation of the outside release lever will not open the vehicle latch (1).

18. The vehicle latch (1) as in claim 1, wherein the actuator gear (10) includes a cam face (10a) integrally formed with the actuator (10) for contacting and rotating a release lever (14) when the actuator gear (10) is rotated into the release position, wherein the release lever (14) is configured to be rotated by an outside release lever when a locking mechanism (45) of the vehicle latch is in an unlocked state.

19. The vehicle latch (1) as in claim 18, wherein the locking mechanism (45) further comprises a bypass lever (23) rotatably mounted to the release lever (14), the bypass lever (23) operably coupling an outside release lever (25) to the release lever (14).

20. A method for power opening and power unlocking a vehicle latch (1) with a single motor (50), comprising:
rotating an actuator gear (10) with the single motor (50) about an axis in a first direction from a home position to a release position and a second direction opposite to the first direction from either the release position or only from the home position to a second position, wherein rotation of the actuator gear (10) to the release position opens the vehicle latch (1) and rotation of the actuator gear (10) from only the home position to the second position unlocks the vehicle latch such that operation of an outside release lever will open the vehicle latch (1).
